(19) United States
(12) Patent Application Publication
(10) Pub. No.: US 2006/0080643 A1
(43) Pub. Date: Apr. 13, 2006

(54) Program processing apparatus

(76) Inventors: Hajime Ogawa, Suita-shi (JP); Toshiyuki Sakata, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/233,023

(22) Filed: Sep. 23, 2005

(30) Foreign Application Priority Data
Oct. 8, 2004 (JP) 2004-296287

(51) Int. Cl. G06F 9/44

(52) U.S. Cl. 717/126; 717/143

(57) ABSTRACT

A program processing apparatus, which can correct a source program by automatically inserting hint information so that a satisfactory optimization can be performed even in the case where the user has not given hint information to a compiler, automatically inserts, into the source program, hint information given to the compiler, and includes: a syntax analysis unit which analyzes a syntax of the source program and generates analysis information; and a hint information insertion unit which creates a program by inserting hint information that is logically consistent and that is given to the compiler into the source program based on the analysis information, and outputs the created program.

### BACKGROUND OF THE INVENTION

(1) Field of the Invention

The present invention relates to a program processing apparatus which corrects a source program written in a high-level language such as the C language. The present invention particularly relates to a program processing apparatus which corrects a source program by inserting hint information that is given to a compiler which converts the source program into a machine-language program.

(2) Description of the Related Art

Recently, development man-hour increases along with increases in the number of media processing application programs and the number of types thereof, application development using a high-level language is becoming a necessity even in the field of media processing. This leads to attempts to realize the media processing application using a high-level language. With this regard, the user expects a realization of a more precise tuning in the development using a high-level language. It is therefore necessary to control in detail optimization strategy performed by a compiler.

Two methods are provided for a method of controlling such optimization strategy: one is to directly give, to a compiler, directives regarding a certain optimization; and the other is to support an optimization carried out by a compiler, by presenting the compiler with static information of the entire program.

One of the methods for realizing the two control methods is to instruct a compiler using pragmas. A pragma is a description that is dependent on language processing system and that gives some information to the compiler.

The following describes an example of a pragma. FIG. 1 shows an example of a source program that includes a pragma that directly gives directives related to optimization. A pragma “#pragma_software_pipelining” is a pragma for giving a directive so that a software pipelining optimization is performed for a loop process which is written by the user immediately after the description of the pragma. The compiler performs the software pipelining optimization for the loop process, based on the directives given through the pragma. Software pipelining is a technique of simultaneously executing different iterations.

FIG. 2 shows an example of a source program which includes a pragma that shows static information of the entire program to the compiler. A pragma “#pragma_min_iteration=5” is a pragma by which the user assures that an iteration of loop process is executed at least for five times. The compiler, for example, judges whether or not the software pipelining optimization is feasible based on the pragma. If such optimization is feasible, the compiler performs it.

The pragma mentioned above is described in detail in Japanese Laid-Open Application No. 2004-38597.

In the two control methods described above, however, the user has to write a pragma in such a manner that the pragma does not logically contradict with the actual program. Since the user can only passively add a pragma within the range analyzable by the user in order to avoid the generation of a wrong machine-language program, this leads to a problem that a satisfactory optimization cannot be performed.

It is required that the user analyzes plural modules in the program and writes a pragma in the program, however, the user may add a contradictory pragma by mistake due to the complexity of the relationship in which the modules are called. In such case, the compiler optimizes intermediate codes based on the directive indicated in the wrong pragma, which causes a problem that the compiler creates a wrong machine-language program.

### SUMMARY OF THE INVENTION

The present invention is conceived in view of the above problems, and a first object of the present invention is to provide a program processing apparatus that can correct a source program by automatically inserting hint information as represented by a pragma, so that a satisfactory optimization can be performed even in the case where the user has not given such hint information to a compiler.

A second object of the present invention is to provide a program processing apparatus that can correct a source program by checking the hint information as represented by a pragma so that a satisfactory optimization can be performed even in the case where the user proactively gives such hint information to the compiler.

A third object of the present invention is to provide a program processing apparatus that can correct a source program by checking the hint information as represented by a pragma, so that the compiler may not create a wrong machine-language program.

In order to achieve the above objects, the program processing apparatus according to the present invention (a) receives a first program, (b) creates a second program by inserting hint information into the first program, the hint information being logically consistent and being given to a compiler, and (c) outputs the second program. It is preferable that the program processing apparatus includes: a syntax analysis unit which analyzes a syntax of the first program for generating analysis information; and a hint information insertion unit which (a) creates the second program by inserting the hint information into the first program based on the analysis information, and (b) outputs the second program.

Thus, the hint information which is logically consistent and is given to the compiler is added to the first program, based on the analysis information. Therefore it is possible to correct the source program by automatically inserting the hint information represented by a pragma, so that a satisfactory optimization can be performed even in the case where the hint information is not given to the compiler. Note that such hint information includes both of the following: hint information that directly gives directives related to a certain optimization; and hint information that supports the optimization performed by the compiler by presenting the compiler with static information of the entire program.

More preferably, the syntax analysis unit statically analyzes the syntax of the first program, for generating the analysis information, and the hint information insertion unit (a) creates the second program by inserting static information as the hint information into the first program based on the analysis information, the static information being obtained by statically analyzing a program, and (b) outputs the second program. The syntax analysis unit may also analyze the number of iterations of loop process included in the first program, for generating the analysis information which includes the number of iterations of the loop process, and the hint information insertion unit may (a) create the second program by inserting hint information into the first program based on the analysis information, the hint information being related to the number of iterations of the loop process, and (b) output the second program. For example, the hint information insertion unit (a) creates the second program by inserting information as the hint information into the first program based on the analysis information, the information indicating a smallest number or a largest number of the number of iterations of the loop process, and (b) outputs the second program.

Thus, it is possible to automatically insert, into the program, the hint information related to the number of iterations of the loop process. For example, by adding the minimum number of iterations of the loop process as the hint information, whether or not software pipelining is applicable is judged for the loop process based on the minimum number of iterations specified in the hint information. In the case where software pipelining is applicable, optimization is performed so that software pipelining may be performed for the loop process.

It is more preferable that the syntax analysis unit is operable to analyze a placement of data included in the first program, for generating the analysis information which includes the placement of the data, and the hint information insertion unit (a) creates the second program by inserting hint information into the first program based on the analysis information, the hint information being related to the placement of the data, and (b) outputs the second program. The hint information insertion unit may include: an alignment judgment unit which judges, based on the analysis information, whether or not the data included in the first program is aligned by a predetermined value; and a program output unit operable, in the case where the alignment judgment unit judges that the data is aligned by a predetermined value, (a) to create the second program by inserting information as the hint information into the first program, the information specifying the data and indicating that the data is aligned by the predetermined value, and (b) to output the second program.

Thus, it is possible to automatically insert, into the program, the hint information related to a placement of data. By adding such hint information, the compiler can perform optimization of loading or writing at one time plural pieces of data from the memory, using a pair instruction. In this way, it is possible to reduce the number of times for memory access and also to increase the speed of processing.

More preferably, the syntax analysis unit is operable to analyze an area accessed by a pointer variable included in the first program, for generating the analysis information which includes a result of the analysis, and the hint information insertion unit (a) creates the second program by inserting hint information into the first program based on the analysis information, the hint information being related to the area accessed by the pointer variable, and (b) outputs the second program. The hint information insertion unit may include: an overlap judgment unit which judges, based on the analysis information, whether or not the area accessed by the pointer variable included in the first program overlaps with an area accessed by another pointer variable; and a program output unit operable, in the case where the overlap judgment unit judges that the areas do not overlap with each other, (a) to create the second program by inserting information as the hint information into the first program, the information indicating that the area accessed by the pointer variable does not overlap with the area accessed by the another pointer variable, and (b) to output the second program. For example, the first and second programs are written in a language compliant with ISO/IEC 9899:1999-Programming Language C, and the hint information is a combination of the pointer variable and a “restrict” description.

By inserting a “restrict” description into the program, it is shown that an area indicated by a pointer variable “r1” and an area indicated by a pointer variable “r2” does not overlap with each other. In such case, the compiler can perform optimization so that the order of executing an instruction to write data into the former area and an instruction to write data into the latter area may be switched, and to speed up the processing.

It is more preferable that the syntax analysis unit analyzes reading of data from a variable included in the first program or writing of data into the variable, for generating the analysis information which includes a result of the analysis, and the hint information insertion unit (a) creates the second program by inserting hint information into the first program based on the analysis information, the hint information being related to reading of data from the variable or writing of data into the variable, and (b) outputs the second program. For example, the hint information insertion unit includes: a writing judgment unit which judges, based on the analysis information, whether or not an access to the variable included in the first program starts with writing of data; and a program output unit operable, in the case where the writing judgment unit judges that the access to the variable starts with writing, (a) to create the second program by inserting information as the hint information into the first program, the information specifying the variable and indicating that the access to the variable starts with writing of data, and (b) to output the second program.

Thus, it is possible to insert automatically, into the program, the hint information related to read of data from a variable or write of data into a variable. By inserting, into the program, the information that specifies a variable and an access to the variable starts with write of data, as the hint information, in the case where a memory access occurs in a computer equipped with a cache memory, the compiler can only allocate an area based on the pragma, and perform optimization so that a transfer (pre-fetch processing) of the value of the variable from a main memory to the cache memory is not operated. This can reduce an amount of the time required for memory access at the execution of a machine-language program.

It is also preferable that the syntax analysis unit analyzes a static frequency at which a branch condition included in the first program is satisfied and a static frequency at which the branch condition is not satisfied, for generating the analysis information which includes a result of the analysis, and the hint information insertion unit (a) creates the second program by inserting hint information into the first program based on the result of the analysis, the frequency at which the branch condition is satisfied and the frequency at which the branch condition is not satisfied, and (b) outputs the second program. For example, the hint information insertion unit includes: a possibility judgment unit that judges that the branch condition included in the first program will be satisfied, based on the analysis information; and a program output unit operable, in the case where it is judged that there is a high probability that the possibility judgment unit judges that the branch condition included in the first program will be satisfied, (a) to create the second program by inserting hint information into the first program, the hint information indicating that there is a high possibility that the branch condition will be satisfied, and (b) to output the second program.

Thus, it is possible to automatically insert, into the program, the hint information related to a frequency at which a branch condition is true and a frequency at which the branch condition is false. Also, by inserting, into the program, the hint information indicating that there is a high possibility that a branch condition will be true or that there is a high possibility that the branch condition will be false, the compiler optimizes an arrangement of machine-language instructions based on the hint information so that an instruction sequence which is executed at the time when a conditional expression using an if statement written in the C language is true is executed with higher priority than an instruction sequence executed at the time when the if statement is false, that is, an instruction sequence specified by an else statement. Thus, it is possible to decrease an amount of the time required for the execution of a machine-language program.

More preferably, the hint information is information which gives a directive on an optimization method to be applied by a compiler to optimize a program. The syntax analysis unit may analyze the number of iterations of loop process included in the first program, for generating analysis information which includes the number of iterations of the loop process, and the hint information insertion unit may (a) create the second program by inserting hint information into the first program based on the analysis information, the hint information giving a directive on a loop unrolling optimization of loop process, and (b) output the second program.

Thus, it is possible to insert, into the program, the hint information that directly instructs the compiler to perform loop unrolling optimization. By adding such hint information to the first program, the compiler can perform loop unrolling for the specified loop process. This allows the loop process to be executed with high speed at the execution of a machine-language program.

It is further preferable that the syntax analysis unit analyzes the number of iterations of loop process included in the first program, for generating analysis information which includes the number of iterations of the loop process, and the hint information insertion unit (a) creates the second program by inserting hint information into the first program based on the analysis information, the hint information giving a directive on a software pipelining optimization of loop process, and (b) outputs the second program.

Thus, it is possible to automatically insert, into the program, the hint information that directly instructs the compiler to perform software pipelining optimization. By adding such hint information to the first program, the compiler can perform software pipelining optimization for the specified loop process. This allows the loop process to be executed with high speed at the execution of a machine-language program.

More preferably, the syntax analysis information unit analyzes an alignment value of data included in the first program, for generating analysis information which includes a result of the analysis, and the hint information insertion unit includes: a condition judgment unit which judges, based on the analysis information, whether or not the following condition is satisfied: the alignment value of the data included in the first program is two or more times larger than the size of the data; and a program output unit which (a) creates the second program by inserting hint information into the first program, the hint information giving, for the data which satisfies the condition, a directive on an optimization of data access based on a generation of a pair instruction, and (b) outputs the second program.

Thus, it is possible to automatically insert, into the program, the hint information that directly instructs the compiler to output a pair instruction. By adding such hint information to the data as described above, the compiler can issue a pair instruction for loading or writing at one time the data from the memory. In this way, it is possible to reduce the number of times for memory access at the time of executing a machine-language program.

It is also preferable that the hint information is information which specifies a variable and gives a directive on an optimization of control processing to be performed on a cache memory. For example, the syntax analysis unit analyzes reading of data from a variable included in the first program or writing of data into the variable, for generating analysis information which includes a result of the analysis, and the hint information insertion unit includes: a writing judgment unit which judges, based on the analysis information, whether or not an access to the variable included in the first program starts with writing of data; and a program output unit operable, in the case where the writing judgment unit judges that the access to the variable starts with writing of data, (a) to create the second program by inserting hint information into a position immediately before a position in which the writing of data into the variable is indicated, in the first program, the hint information specifying the variable and instructing that an area should be allocated on the cache memory for storing a value of the variable, and (b) to output the second program.

Thus, it is possible to automatically insert, into the program, the hint information that gives a directive on control processing performed on a cache memory. By inserting, into the program, the hint information as described above into the first program, the complier can perform, based on the hint information, optimization so that an area for storing a value of a variable specified in the hint information may be allocated in the cache memory, in a computer equipped with a cache memory. This reduces an amount of the time required for memory access at the execution of a machine-language program.

More preferably, the first program includes first hint information, and the hint information insertion unit (a) creates the second program by inserting second hint information into the first program based on the analysis information, the second hint information being logically consistent and being given to the compiler, and (b) outputs the second program.

Thus, it is possible to check the hint information and correct the source program (i.e. the first program), so that a satisfactory optimization can be performed even in the case where the user proactively inserts, into the first program for the compiler, the hint information as presented by a pragma. It is also possible to check the information as represented by a pragma and correct the source program (i.e. the first program) so that the compiler may not create a wrong machine-language program.

The hint information insertion unit may correct a logical error in the first hint information and to generate the second hint information which reflects the correction.

Thus, it is possible to compile the program that includes the first hint information even in the case where the compiler can only use the second hint information, which promotes the use of assets.

Another aspect of the program processing apparatus according to the present invention is a program processing apparatus which inserts, into a program, hint information given to a compiler, and includes: a hint information insertion unit which (a) receives, as inputs, a first program and analysis information which is a result of analyzing a syntax of another program different from the first program, (b) creates a second program by inserting hint information into the first program based on the analysis information, the hint information being logically consistent and being given to the compiler, and (c) outputs the second program.

Thus, the hint information which is logically consistent and is given to the compiler is added to the first program based on the analysis information inputted from outside. Therefore, it is possible to correct a source program by automatically inserting the hint information so that a satisfactory optimization may be performed even in the case where the user did not give, to the compiler, the hint information as represented by a pragma.

It should be noted that the present invention can be realized not only as the program processing apparatus equipped with such characteristic units as described above, but also as a program processing method that includes the characteristic units included in the program processing apparatus, as steps. The present invention can be realized even as a program that causes the computer to function as such characteristic units included in the program processing apparatus. Such program can be surely distributed via a storage medium such as a CD-ROM and a communication network such as the Internet.

According to the present invention, it is possible to provide the program processing apparatus that can correct a source program by automatically inserting the hint information as represented by a pragma so that a satisfactory optimization may be performed even in the case where the user has not given the hint information to the compiler.

It is also possible to provide the program processing apparatus that can correct a source program by automatically inserting the hint information so that a satisfactory optimization can be performed even in the case where the user proactively gives the hint information to the compiler.

Moreover, it is possible to provide the program processing apparatus that can check the hint information and correct a source program, so that the compiler may not create a wrong machine-language program.

With regard to the further information about technical background to this application, the disclosure of Japanese Patent Application No. 2004-296287 filed on Oct. 8, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows an example of a source program that includes a pragma that directly gives directives related to optimization;

FIG. 2 shows an example of a source program that includes a pragma that presents a compiler with static information of the entire program;

FIG. 3 is a function block showing a structure of a program processing apparatus;

FIG. 4A shows an example of a program which includes a function “func1” that includes loop process;

FIG. 4B shows an example of a program that includes a main function as well as functions “func2” and “func3”;

FIG. 5 is a flowchart showing processing executed by a syntax analysis unit;

FIG. 6 shows an example of a call flow graph;

FIG. 7 shows an example of analysis information;

FIG. 8 is a flowchart showing processing executed by a hint information insertion unit;

FIG. 9 shows an example of a program that is a result of an output performed by the hint information insertion unit;

FIG. 10A shows an example of a program which includes functions “func1”, “func2” and “func3”;

FIG. 10B shows an example of a program which includes a main function;

FIG. 11 shows an example of a call flow graph created by a syntax analysis unit based on the programs shown in FIGS. 10A and 10B;

FIG. 12 shows an example of analysis information created by the syntax analysis unit;

FIG. 13 is a flowchart showing processing executed by the hint information insertion unit;

FIG. 14 shows an example of a program that is a result of an output performed by the hint information insertion unit;

FIG. 15 shows an example of a program inputted by the program processing apparatus;

FIG. 16 shows an example of a call flow graph created by the syntax analysis unit based on the program shown in FIG. 15;

FIG. 17 shows an example of analysis information created by the syntax analysis unit;

FIG. 18 is a flowchart showing processing executed by the hint information insertion unit;

FIG. 18 is a flowchart showing processing executed by the hint information insertion unit;

FIG. 19 shows an example of a program that includes hint information;

FIG. 20 shows an example of a program inputted by the program processing apparatus;

FIG. 21 shows an example of a call flow graph created by the syntax analysis unit based on the program shown in FIG. 20;

FIG. 22 shows an example of analysis information created by the syntax analysis unit;

FIG. 23 is a flowchart showing processing executed by the hint information insertion unit;

FIG. 24 shows an example of the program that includes hint information;

FIG. 25 shows an example of a program inputted by the program processing apparatus;

FIG. 26 is a call flow graph created as a result of the processing described in S202 shown in FIG. 5;

FIG. 27 shows analysis information created as a result of the processing described in S203 and S204 shown in FIG. 5;

FIG. 28 is a flowchart showing processing executed by the hint information insertion unit;

FIG. 29 shows an example of a program that is a result of an output performed by the hint information insertion unit;

FIG. 30 shows an example of a program inputted into the program processing apparatus;

FIG. 31 shows an example of a call flow graph;

FIG. 32 shows an example of analysis information;

FIG. 33 shows an example of a program that includes a result of an output performed by the hint information insertion unit;

FIG. 34 shows an example of a program inputted into the program processing apparatus;

FIG. 35 shows a call flow graph created as a result of the processing described in S202 shown in FIG. 5;

FIG. 36 is analysis information created as a result of the processing described in S203 and S204 shown in FIG. 5;

FIG. 37 is a flowchart showing processing executed by the hint information insertion unit;

FIG. 38 is an example of a program that is a result of an output described by the hint information insertion unit;

FIG. 39 shows an example of a program inputted into the program processing apparatus;

FIG. 40 shows a call flow graph created as a result the processing described in S202 shown in FIG. 5;

FIG. 41 shows analysis information created as a result of the processing described in S203 and S204 shown in FIG. 5;

FIG. 42 is a flowchart showing processing executed by the hint information insertion unit;

FIG. 43 shows an example of a program that includes the hint information;

FIG. 44 is a diagram for describing correction and replacement of hint information;

FIG. 45 is another diagram for describing correction and replacement of hint information;

FIG. 46 is a diagram for describing processing executed by the program processing apparatus for outputting a compile option;

FIG. 47 is a function block diagram showing another structure of the program processing apparatus;

FIG. 48 shows an example of a program inputted by the program processing apparatus;

FIG. 49 shows an example of analysis information inputted into the program processing apparatus; and

FIG. 50 shows an example of a program that includes hint information.

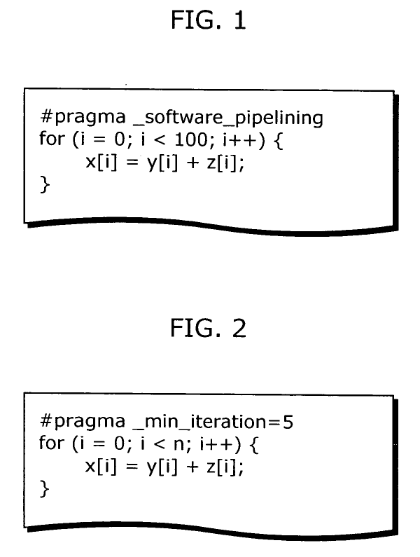

### DESCRIPTION OF THE PREFERRED EMBODIMENT(S)

The following describes the program processing apparatus according to the present invention with reference to the diagrams.

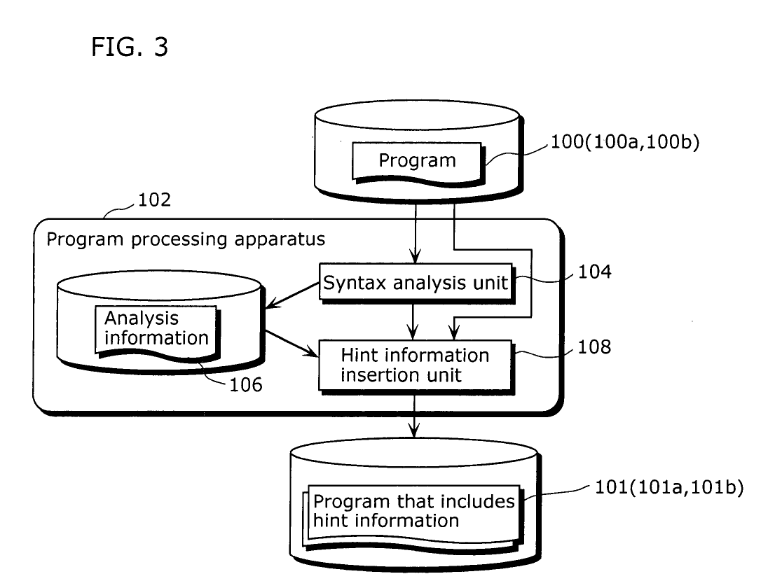

FIG. 3 is a function block diagram showing the structure of the program processing apparatus. A program processing apparatus 102 is an apparatus which receives a program 100 written in a high-level language and automatically creates a program 101 that includes hint information as represented by a pragma and that is given to a compiler. Such program processing apparatus 102 includes a syntax analysis unit 104 and a hint information insertion unit 108. The program 100 inputted into the program processing apparatus 102 normally is a program which is described by the user and does not include the hint information.

The syntax analysis unit 104 is a processing unit that receives the program 100 (also arbitrarily referred to as “programs 100a and 100b” in the case where the program 100 consists of plural files), performs a normal syntax analysis to be used by a compiler or the like for the program 100, and outputs a result of the analysis as analysis information 106.

The hint information insertion unit 108 is a processing unit which inserts the hint information that can be inserted into the program 100, based on the program 100 and the analysis information 106, and outputs the program 101 (also to be arbitrarily referred to as “programs 101a and 101b” in the case where the program 101 consists of plural files) which includes hint information.

Note that the processing executed by the syntax analysis unit 104 and the processing executed by the hint information insertion unit 108 differ depending on each of the embodiments which will be mentioned later. Therefore, the detail is described in each of the embodiments.

### First Embodiment, Hint Information Related to Number of Iterations

The present embodiment describes the program processing apparatus which automatically inserts, into the program, hint information related to the number of iterations of loop process (e.g. “for”, “while” and “do”). The followings are examples of such hint information.

(1) Hint information which specifies a maximum number of iterations with regard to one loop process.

(2) Hint information which specifies a minimum number of iterations with regard to one loop process.

(3) Hint information which specifies that the number of iterations with regard to one loop process is always an even number.

(4) Hint information which specifies that the number of iterations with regard to one loop process is always an odd number.

The following describes the processing executed by the program processing apparatus 102 which automatically creates a program 101 that includes such hint information as described above.

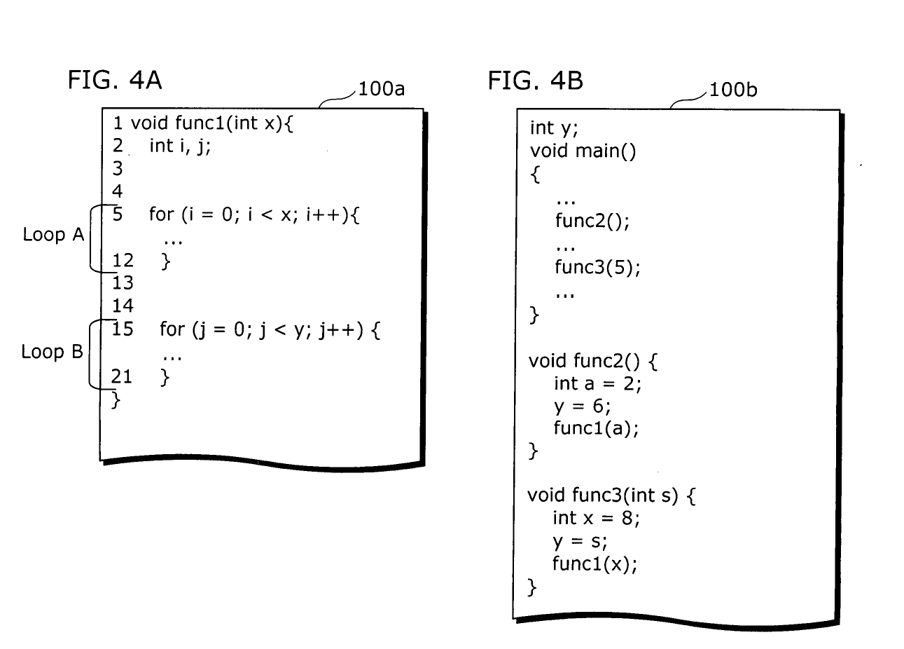

FIGS. 4A and 4B are examples of the program inputted into the program processing apparatus 102. FIG. 4A shows an example of a program which includes a function “func1” that includes plural loop process. FIG. 4B shows an example of a program which includes a main function and functions “func2” and “func3”.

The following describes the processing executed by the syntax analysis unit 104 and the hint information insertion unit 108 in the case where the programs 100a and 100b are inputted.

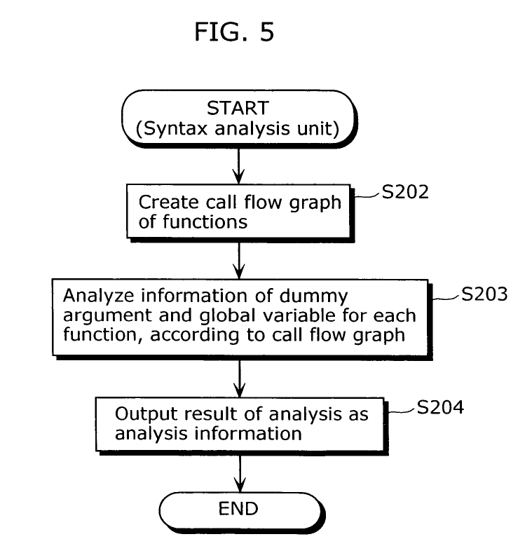

FIG. 5 is a flowchart showing the processing executed by the syntax analysis unit 104. The syntax analysis unit 104 analyzes the entire program 100 (programs 100a and 100b), and creates a call flow graph of the functions (S202). This is as same as the one created by a general compiler.

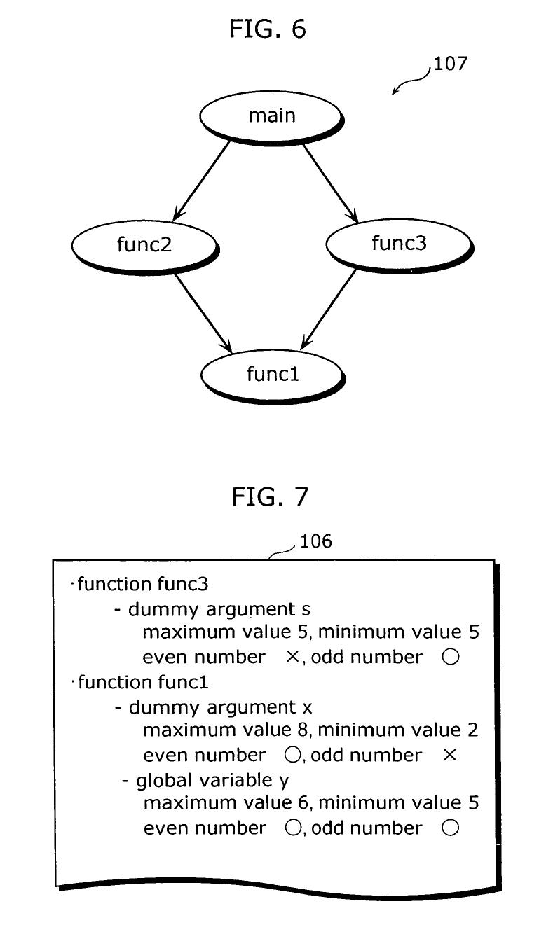

FIG. 6 shows an example of the call flow graph 107. A call flow graph 107 shown in FIG. 6 is created based on the programs 100a and 100b respectively shown in FIGS. 4A and 4B. The call flow graph shows that the main function calls the functions “func2” and “func3, and also that the function “func2” calls the function “func1” while the function “func3” calls the function “func1”. In this way, the call flow graph shows a call relationship between the functions by use of directions indicated by arrows.

As shown in FIG. 5, the syntax analysis unit 104 analyzes a value of a global variable or a dummy argument when each function is called, based on the created call flow graph 107 (S203). In the present embodiment, the syntax analysis unit 104 analyzes maximum value and minimum value of the value possibly indicated by a global value or a dummy argument, and also analyzes whether or not the global value or the dummy argument indicates an even number or an odd number. Note that the syntax analysis 104 may analyze a local variable within a function.

The syntax analysis unit 104 outputs a result of the analysis as analysis information 106 (S204). FIG. 7 shows an example of the analysis information. The analysis information 106 in FIG. 7 shows a part of the analysis. The analysis information 106 shows that both of a maximum value and minimum value of a dummy argument “s” of the function “func3” are “5”, and the dummy argument may take an odd number, but not an even number. This is based on the following analysis: the call flow graph 107 shows that the function “func3” is called by the main function; and the program 101b shows that an actual argument of the function “func3” within the main function is “5” and the function “func3” is called only once. Thus, the analysis information 106 as described above can be obtained.

With regard to a global variable “y” in the function “func1”, the analysis information 106 shows that the maximum value is “6” and the minimum value is “5”, and the global variable “y” may possibly indicate either an odd or even value. This is based on the following analysis. The call flow graph 107 shows that the function “func1” is called by the functions “func2” and “func3”. In the function “func2”, “6” is substituted into the global variable “y”. In the function “func3”, a value of the dummy argument “s” is substituted into the global variable “y”. The call flow graph shows here that the function “func1” is called by the main function. Examining an actual argument of the function “func3” in the main function, it turns out to be “5”. Therefore, a value of the dummy argument “s” in the function “func3” is “5”. Namely, a value of the global variable “y” in the function “func3” is also “5”. Based on the above, a value possibly indicated by the global variable in the function “func3” is “5” or “6”. The analysis information 106 as described above can be therefore obtained. By performing the similar analysis, the analysis information 106 as shown in FIG. 7 can be obtained.

The following describes the processing executed by the hint information insertion unit 108.

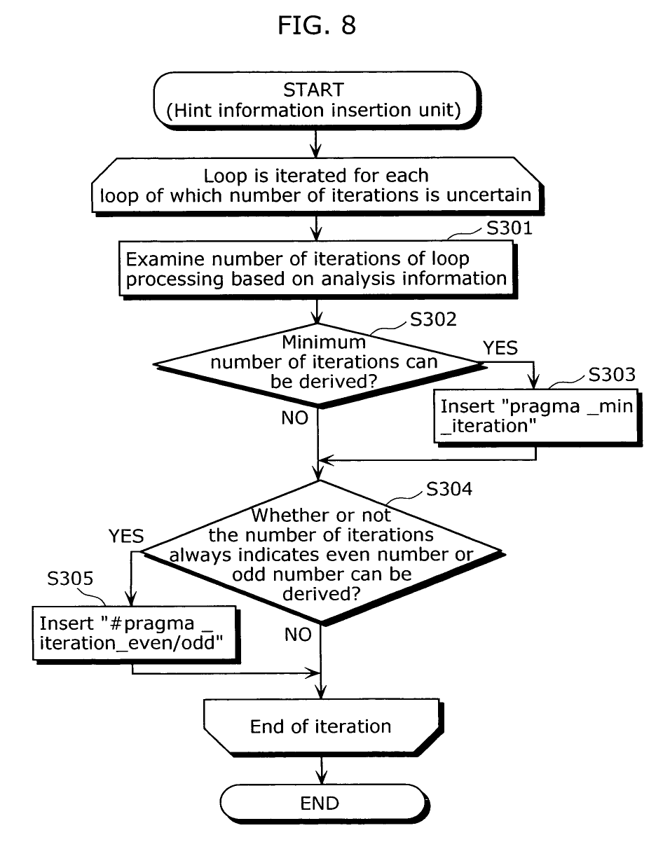

FIG. 8 is a flowchart showing the processing executed by the hint information insertion unit 108. The hint information insertion unit 108 repeats the following processing for each loop process included in the programs 100a and 100b. As shown in FIG. 4A, two loop process of loop A and loop B are included in the program 100a. The following processing shall be therefore executed for each of the loops A and B.

The hint information insertion unit 108 examines the number of iterations for a current loop process based on the analysis information 106 (S301). The hint information insertion unit 108 checks whether or not the minimum number of iterations can be derived for the current loop process (S302). In the case where the minimum number of iterations can be derived (YES in S302), the hint information insertion unit 108 inserts, into the program 100a, a pragma “#pragma_min_iteration=n” where n denotes a minimum number of iterations, which is hint information that specifies the minimum number of iterations for the current loop process (S303). This pragma is the second type of the hint information as described above.

Next, the hint information insertion unit 108 examines it is possible to derive whether or not the number of iterations of the current loop process always indicates an even number or an odd number (S304). In the case where it is possible to derive (YES in S304), the hint information insertion unit 108 inserts, into the program 100a, a pragma “#pragma_iteration_even” that is the hint information which specifies that the number of iterations of loop process always indicates an even number in the case where the number of iterations for the current loop process indicates an even number, and inserts, into the program 100a, a pragma “#pragma_iteration_odd” that is the hint information which specifies that the number of iterations of loop process always indicates an odd number in the case where the number of iterations for the current loop process indicates an odd number (S305). The program 101a that includes hint information is created by the hint information insertion unit 108 inserting such pragma into the program 100a.

The pragma “#pragma_iteration_even” and the pragma “#pragma_iteration_odd” are respectively the third and fourth types of the hint information as described above.

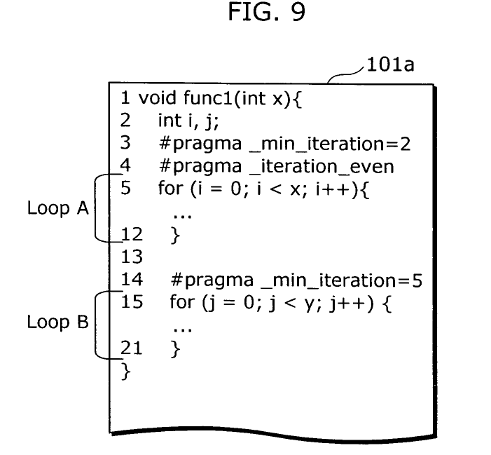

The following describes an example of a result of the insertion of pragma carried out by the hint information insertion unit 108. For example, looking closely at the loop A in the program 100a shown in FIG. 4A, the analysis information 106 shows that a minimum value of a value of a dummy argument “x” that defines the number of iterations of loop process is “2”. Therefore, the minimum number of iterations of the loop A is “2”. Consequently, a pragma “#pragma_min_iteration=2” is inserted as the hint information for the loop A in line 3 of the program 101a, as shown in FIG. 9, that is a result of the output performed by the hint information insertion unit 108.

In the case of loop A, the analysis information 106 shows that the value of the dummy argument “x” always indicates an even number but not an odd number. Therefore, a pragma “#pragma_iteration_even” is inserted as the hint information for the loop A in line 4 of the program 101a.

Similarly, looking closely at the loop B, the minimum number of iterations of the loop B is “5”. Therefore, a pragma “#pragma_min_iteration=5” is inserted as the hint information for the loop B in line 14 of the program 101a.

As described above, according to the present embodiment, it is possible to automatically insert, into the program, the hint information related to the number of iterations of loop process.

By inserting a pragma “#pragma_min_iteration” into the program, judgment on whether or not software pipelining is applicable is made for the loop process based on the minimum number of iterations of loop process specified by the pragma “pragma_min_iteration”. In the case such judgment can be made, software pipelining optimization is performed for the loop process. Software pipelining is a technique of simultaneously executing different iterations.

By inserting a pragma “#pragma_iteration_even” or the pragma “#pragma_iteration_odd” into the program, the compiler can perform loop unrolling optimization based on the pragma. Loop unrolling is one of the loop process speeding-up methods for speeding up an execution speed within the loop process by simultaneously executing plural (“2” in this case) iterations. In the case where the number of iterations to be unrolled is two, process of optimization differs depending on whether the number is even or odd. In the case the number is even, unrolling may be performed without any particular processing, and in the case where the number is odd, iteration has to be executed one more time outside the loop process.

It should be noted that the present embodiment is described using pragmas being one type of hint information which are presented as the second through fourth types. A pragma “#pragma_max_iteration”, however, may be used as the first type of the hint information. This pragma indicates a maximum number of iterations for the loop process (e.g. “for”, “while”, and “do”) that follows immediately after the hint information. For example, in the case where the maximum number of iterations of the loop process in the program 100 is 10, a pragma “#pragma_max_iteration=10” is inserted into the program 100 so that the program 101 that includes hint information may be created.

In the case where the hint information insertion unit 108 can insert the hint information without analysis information 106, the hint information insertion unit 108 may thus insert the hint information without the analysis information 106. For example, in the case where the number of iterations of loop process is defined by a constant instead of a variable, it is possible for the hint information insertion unit 108 to obtain the minimum number of iterations of loop process without referring to the analysis information 106.

### Second Embodiment, Hint Information Related to Pointer Variables

In the present embodiment, the program processing apparatus which automatically inserts, into a program, hint information related to pointer variables will be explained. The followings are the examples of such hint information.

(1) Hint information which specifies an alignment value of data indicated by a pointer variable.

(2) Hint information which indicates that areas respectively indicated by a pointer variable do not overlap with each other. The following describes the processing executed by the program processing apparatus 102 which automatically creates a program 101 that includes such hint information as described above.

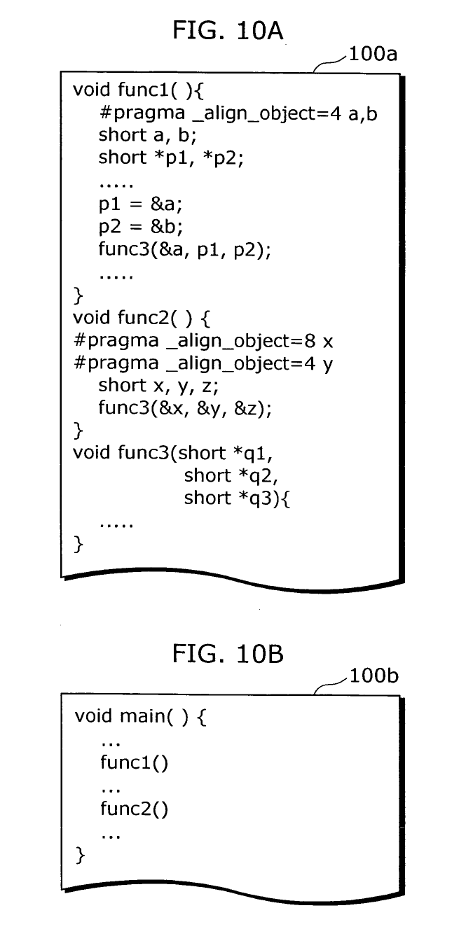

FIGS. 10A and 10B respectively shows an example of the program inputted into the program processing apparatus 102. FIG. 10A shows an example of the program that includes functions “func1”, “func2” and “func3” while FIG. 10B shows an example of the program that includes a main function.

A program 101a shown in FIG. 10A and a program 101b shown in FIG. 10B are to be linked after each of the programs is compiled.

The pragma “#pragma_align_object” included in the program 100a is a user's directive that the data indicated immediately after the pragma should be aligned by a specified number of bytes. For example, the description of the pragma “#pragma_align_object=4a,b” in the function “func1” is a directive to align the variables “a” and “b” in the main memory in units of 4 bytes. The variables “a” and “b” are short-type variables, each normally requiring 2 bytes. Therefore, in the present embodiment, in the case where the pragma “#pragma_align_object” is not written in the program, the variables of “short” type shall be aligned in units of 2 bytes.

The following describes the processing executed by the syntax analysis unit 104 and the hint information insertion unit 108 in the case where programs 100a and 100b are inputted.

The syntax analysis unit 104 executes the same processing as described in the flowchart shown in FIG. 5. However, a target to be analyzed is different from the target analyzed in the processing described in S203. Namely, the syntax analysis unit 104 analyzes an alignment value of the data indicated by a pointer argument in a function as well as an area indicated by a pointer argument, so as to analyze the possibility that the pointer will indicate the same area as indicated by another pointer.

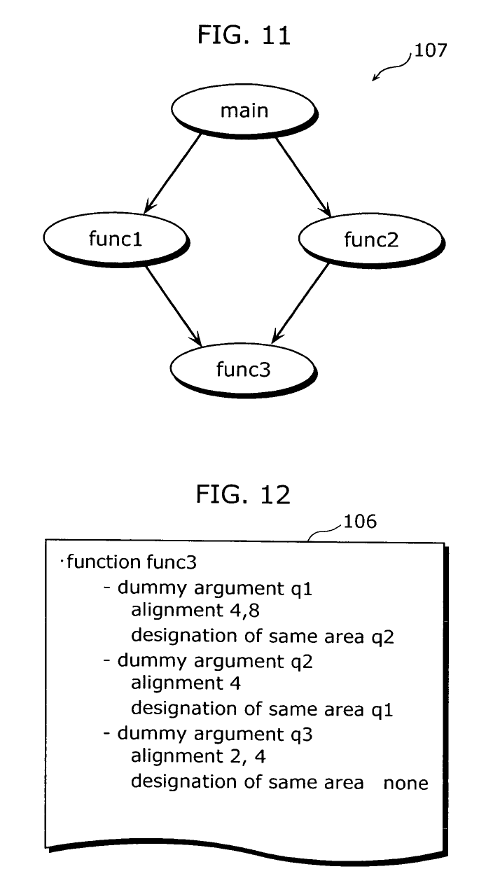

FIG. 11 shows an example of the call flow graph created by the syntax analysis unit 104 based on the programs 101a and 101b respectively shown in FIGS. 10A and 10B. According to the call flow graph 107, a main function calls functions “func1” and “func2”, each calling a function “func3”.

FIG. 12 shows an example of the analysis information 106 generated by the syntax analysis unit 104. In the processing described in S203 shown in FIG. 5, the syntax analysis unit 104 analyzes alignment values of a pointer variable and a global pointer variable when each function is called as well as the possibility that the same area will be indicated by another pointer variable.

For example, a dummy argument “q1” of the function “func3” is considered here. The call flow graph 107 shows that the function “func3” is called by the functions “func1” and “func2”. The data indicated by an actual argument “&a” of the function “func3” within the function “func1” associated with the dummy argument “q1” is aligned in units of 4 bytes according to the pragma “#pragma_align_object=4a,b”. Also, the data indicated by an actual argument “&x” of the function “func3” within the function “func2” associated with the dummy argument “q1” is aligned in units of 8 bytes according to the pragma “#pragma_align_object=8x”. Therefore, an alignment value of the data indicated by the dummy argument “q1” of the function “func3” is 4 or 8.

The dummy arguments “q1” and “q2” of the function “func3” are respectively associated with the actual arguments “&a” and “p1” of the function “func3” within the function “func1”. The actual argument “&a” is substituted into “p1” immediately before a position at which the function “func3” is called in the function “func1”. Therefore, “p1” and “&a” indicate the same value. Consequently, the dummy argument “q2” is obtained as a pointer that may specify the same area as indicated by the dummy argument “q1”.

Similarly, analysis is performed also for the dummy arguments “q2” and “q3” in the same manner, and the analysis information 106 as shown in FIG. 12 can be obtained.

The following describes the processing executed by the hint information insertion unit 108.

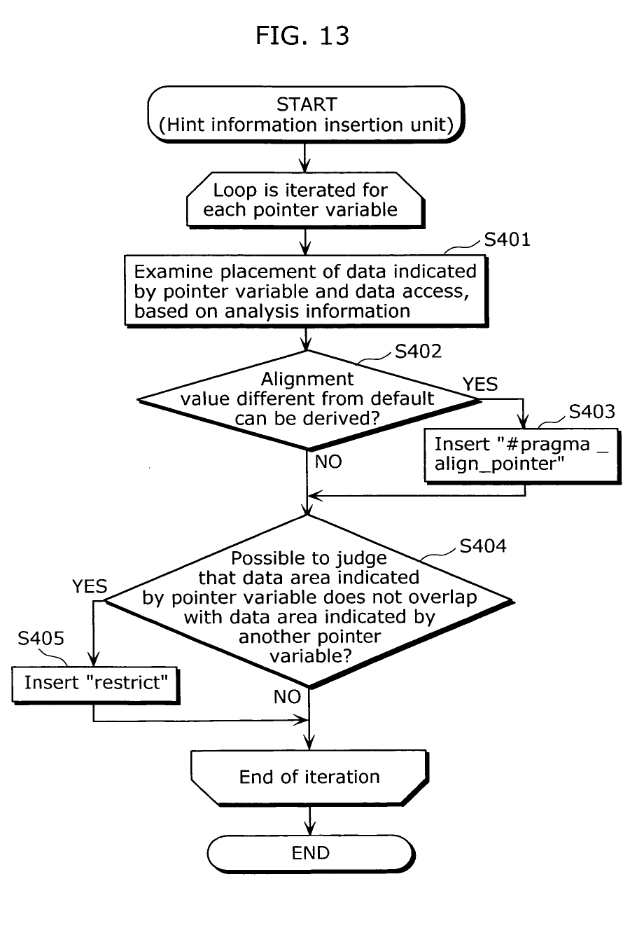

FIG. 13 is a flowchart showing the processing executed by the hint information insertion unit 108. The hint information insertion unit 108 repeats the following processing for each pointer variable included in the programs 100a and 100b. As shown in FIG. 10A, the program 100a includes pointer variables “q1”, “q2” and “q3”.

The hint information insertion unit 108 examines a placement of the data indicated by a pointer variable and data access performed by the pointer variable, based on the analysis information 106 (S401). The hint information insertion unit 108 checks on whether or not it is possible to derive an alignment value that is different from an alignment value of a default of the data indicated by a current pointer variable (S402). An alignment value of a default of the data indicated by a pointer variable is determined according to a type of the pointer variable. For instance, in the case where a pointer variable is a short type, 2 bytes are assigned for its alignment value.

In the case where it is possible to derive an alignment value that is different from an alignment value of a default (YES in S402), the hint information insertion unit 108 inserts, into the program 100a, a pragma “#pragma_align_pointer” that is the hint information which specifies a minimum value of the alignment value of the data indicated by the current pointer variable (S403). For example, in the case where the minimum value of the alignment value for a pointer variable “q” is n, a pragma “#pragma_align_pointer=n q” is inserted into the program 100a. This pragma is the first type of the hint information as presented above.

Next, the hint information insertion unit 108 examines whether or not it is possible to judge that a data area indicated by the current pointer variable does not overlap with a data area indicated by another pointer variable (S404).

In the case where it is possible to judge that the data areas do not overlap with each other (YES in S404), the hint information insertion unit 108 inserts a “restrict” description immediately before a position at which the current pointer variable is written (S405). The “restrict” description is introduced in C99 language (ISO/IEC 9899:1999-Programming Language C), and indicates that areas in the main memory indicated by all the pointer variables specified in a scope of the “restrict” description do not overlap with each other. Such “restrict” description is the second type of the hint information as presented above. By inserting such pragma or “restrict” description into the program 100a, the program 101a that includes hint information can be created.

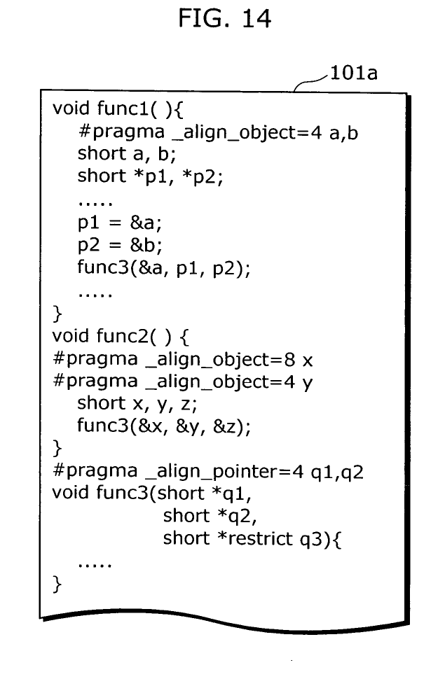

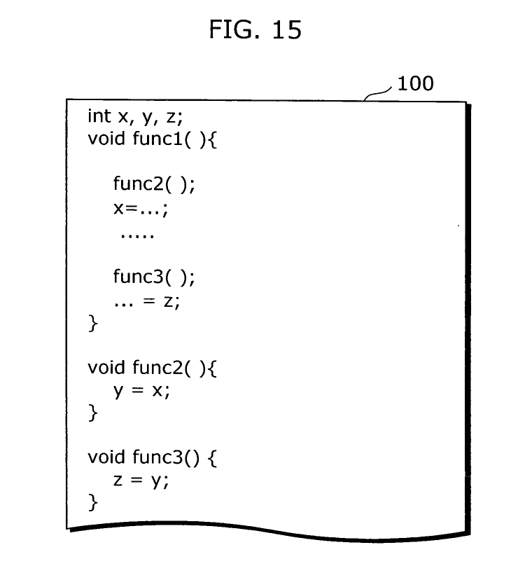

The following describes an example of a result of the insertion of a pragma and a “restrict” description, carried out by the hint information insertion unit 108. For example, focusing on a dummy argument (i.e. pointer variable) “q1” of the function “func3” in the program 100a shown in FIG. 10A, the analysis information 106 shows that an alignment value of the data indicated by the dummy argument “q1” is “4” or “8”. Therefore, a pragma “#pragma_align_pointer=4q1”, which specifies a minimum value of the alignment value of the data indicated by the dummy argument “q1” as an alignment value, is inserted immediately before a position at which the function “func3” is written in the program 101a that is a result of the output performed by the hint information insertion unit 108 and that is shown in FIG. 14. Similarly, a pragma “#pragma_align_pointer=4q2” is inserted immediately before a position at which the function “func3” is written. Note that these two pragmas are described together as a pragma “#pragma_align_pointer=4q1,q2”.

The analysis information 106 also shows that a data area indicated by the dummy argument “q3” does not overlap with a data area indicated by another pointer. Therefore, a “restrict” description is inserted immediately before a position at which the dummy argument “q3” is written in the program 101a.

As described above, according to the present embodiment, it is possible to automatically insert, into the program, the hint information related to a placement of data.

By inserting a pragma “#pragma_align_pointer” into the program, the compiler can perform optimization of loading or writing at one time plural pieces of data from the memory, using a pair instruction. Thus, it is possible to reduce the number of times for memory access and thereby to speed up the processing.

The insertion of a “restrict” description also shows, for example, that the area indicated by a pointer variable “r1” does not overlap with the area indicated by a pointer variable “r2”. In such case, the compiler can perform optimization so that the order of executing an instruction to write data into the former area and an instruction to write data into the latter area may be switched.

It should be noted that, in the above embodiment, a pointer variable being a dummy argument of function is described as an example, however, the embodiment is not restricted to the use of dummy argument. The same processing is executed for a pointer being a global variable, and hint information in inserted into the program.

### Third Embodiment, Hint Information Related to Reading and Writing of Variables

In the present embodiment, the program processing apparatus which automatically inserts, into a program, hint information related to reading and writing of variables will be described. The following is an example of such hint information.

(1) Hint information indicating that an access to a specified variable begins with writing of data, in a position located after the description of the hint information as described above.

The following describes the processing executed by the program processing apparatus 102 which automatically creates a program 101 that includes such hint information.

FIG. 15 shows an example of the program inputted into the program processing apparatus 102. Functions “func1”, “func2” and “func3” are included in a program 100.

The processing executed by the syntax analysis unit 104 and the hint information insertion unit 108 in the case where the program 100 is inputted.

The syntax analysis unit 104 executes the same processing as described in the flowchart shown in FIG. 5. However, a target to be analyzed is different from the target analyzed in the processing described in S203. That is to say that the syntax analysis unit 104 analyzes whether or not reading from and writing into a global variable is described for each of the functions in the program 100.

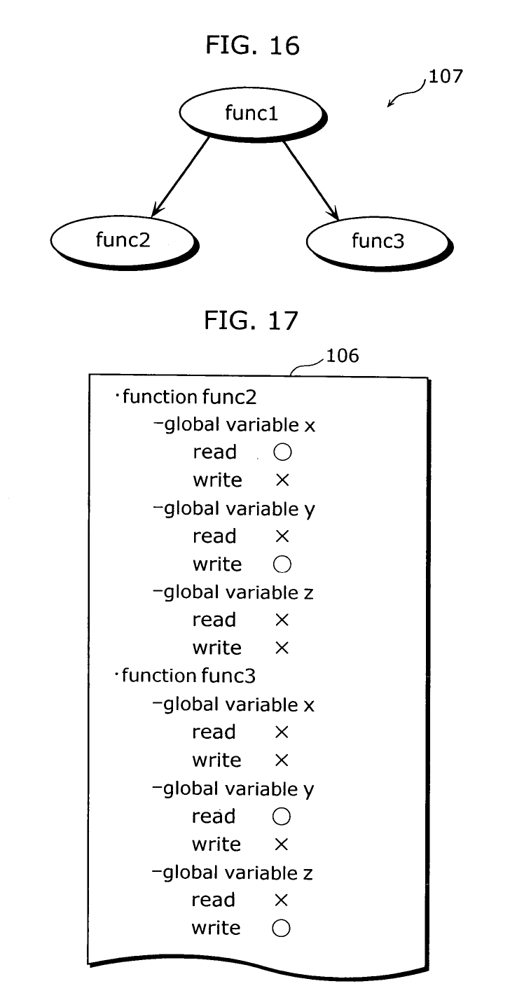

FIG. 16 shows an example of the call flow graph created by the syntax analysis unit 104 based on the program 100 shown in FIG. 15. According to the call flow graph 107, the function “func1” calls the functions “func2” and “func3”.

FIG. 17 shows an example of the analysis information 106 created by the syntax analysis unit 104. In the processing described in S203 shown in FIG. 5, the syntax analysis unit 104 checks on the presence of reading and writing for each global variable in each of the functions.

For example, in the function “func2”, writing of data into a global variable “y” and reading of data from a global variable “x” are executed, whereas in the function “func3”, writing of data into a global variable “z” and reading of data from the global variable “y” are executed. This results in the analysis information 106 shown in FIG. 17. Note that the same processing is executed for the function “func1” so that the analysis information is generated.

The following describes processing executed by the hint information insertion unit 108.

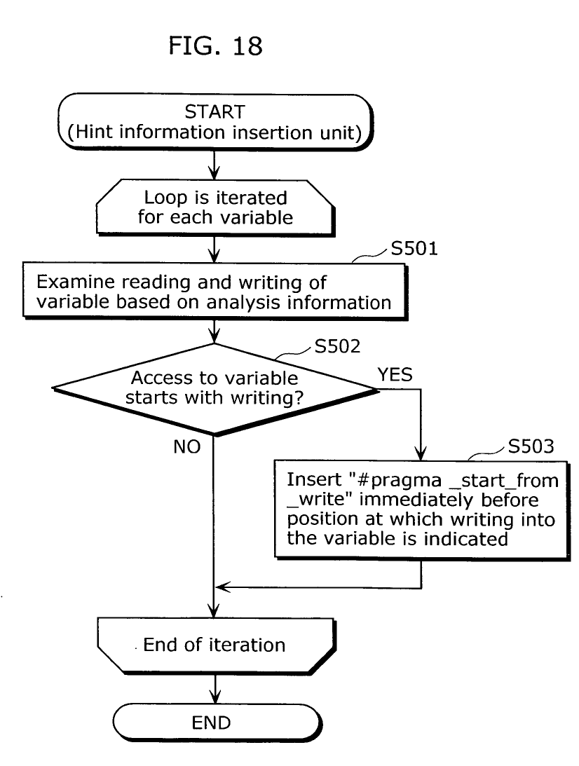

FIG. 18 is a flowchart showing the processing executed by the hint information insertion unit 108. The hint information insertion unit 108 repeats the following processing for each global variable included in the program 100. As shown in FIG. 15, three global variables “x”, “y” and “z” are included in the program 100.

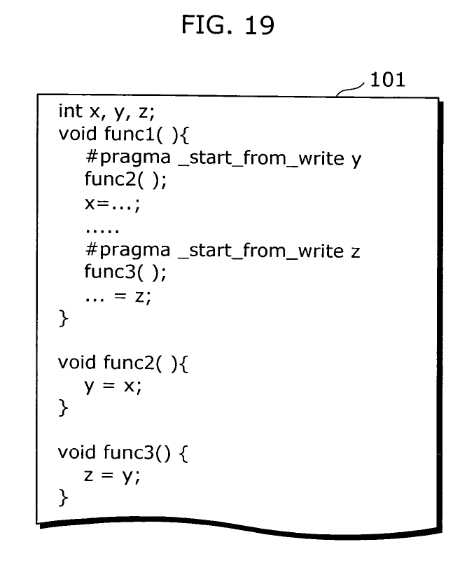

The hint information insertion unit 108 examines reading of data from and writing of data into a current global variable, based on the analysis information 106 (S501). In the case where an access to the current global variable starts with writing of data (YES in S502), the hint information insertion unit 108 inserts a pragma “#pragma_start_from_write” immediately before a position at which an execution of writing into the global variable is indicated (S503). For example, in the case where a global variable is “a”, a pragma “#pragma_start_from_write a” is inserted immediately before a position at which an execution of writing of data into the global variable “a” is indicated. This pragma is the type of the hint information presented above. By inserting such pragma into the program 100, the program 101 which includes hint information, as shown in FIG. 19, is created.

The following describes an example of a result of the insertion of a pragma, carried out by the hint information insertion unit 108. For example, a global variable “y” in the program 100 shown in FIG. 15 is focused. Examining the analysis information 106 for writing of data into the global variable “y”, only writing of data is executed in the function “func2”. This shows that an access to the global variable “y” starts with writing of data when the function “func2” is called. The hint information insertion unit 108 therefore inserts a pragma “#pragma_start_from_write y” immediately before a position at which the function “func2” is called in the function “func1”.

Similarly, the hint information insertion unit 108 inserts a pragma “#pragma_start_from_write z” immediately before a position at which the function “func3” is called in the function “func1”. In this way, a program 101 that includes such hint information is created.

As described above, according to the present embodiment, it is possible to automatically insert, into the program, the hint information related to reading of data from a variable and writing of data into a variable.

By the insertion of a pragma “#pragma_start_from_write”, the compiler can perform optimization based on the pragma so that only an area for storing a value of a variable is allocated, and a transfer (pre-fetch processing) of the value of the variable from a main memory to a cache memory is not operated, in the case where memory access occurs in a computer equipped with the cache memory. Thus, the time required for the memory access can be reduced.

### Fourth Embodiment, Hint Information Related to Static Frequency

In the present embodiment, the program processing apparatus which automatically inserts, into a program, hint information related to static frequency will be described. The followings are the examples of such hint information.

(1) Hint information indicating a high frequency at which a branch condition is true.

(2) Hint information indicating a high frequency at which a branch condition is false.

The following describes the processing executed by the program processing apparatus 102 which automatically creates a program 101 that includes such hint information as described above.

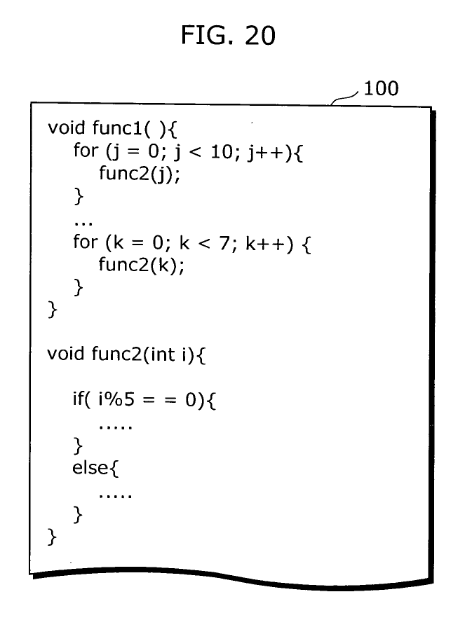

FIG. 20 shows an example of the program inputted into the program processing apparatus 102. Functions “func1” and “func2” are included in a program 100.

The processing executed by the syntax analysis unit 104 and the hint information insertion unit 108 in the case where the program 100 is inputted will be described.

The syntax analysis unit 104 executes the same processing as described in the flowchart shown in FIG. 5. However, a target to be analyzed is different from the target analyzed in the processing described in S203. That is to say that the syntax analysis unit 104 performs frequency analysis on a value of each dummy argument and a value of each global variable in each function.

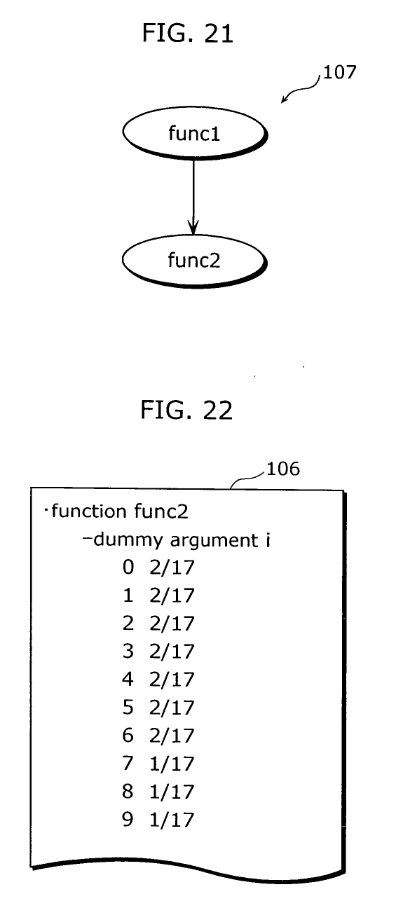

FIG. 21 shows an example of the call flow graph created by the syntax analysis unit 104 based on the program 100 shown in FIG. 20. According to the call flow graph 107, a function “func1” calls a function “func2”.

FIG. 22 shows an example of the analysis information 106 created by the syntax analysis unit 104. As described above, in the processing described in S203 shown in FIG. 5, the syntax analysis unit 104 performs frequency analysis on a value of each dummy argument and each global variable in each of the functions.

For example, in analyzing a frequency of a value of a dummy argument “i” in the function “func2”, there is a possibility that the function “func2” will be called by the function “func1” for a total of 17 times, and the frequency of the value of the dummy argument “i” is indicated as the analysis information 106. For example, the number of times the dummy argument “i” indicates “0” is two. Therefore, it is shown that a probability at which the dummy argument “i” indicates “0” is 2 out of 17.

Next, processing executed by the hint information insertion unit 108 will be described.

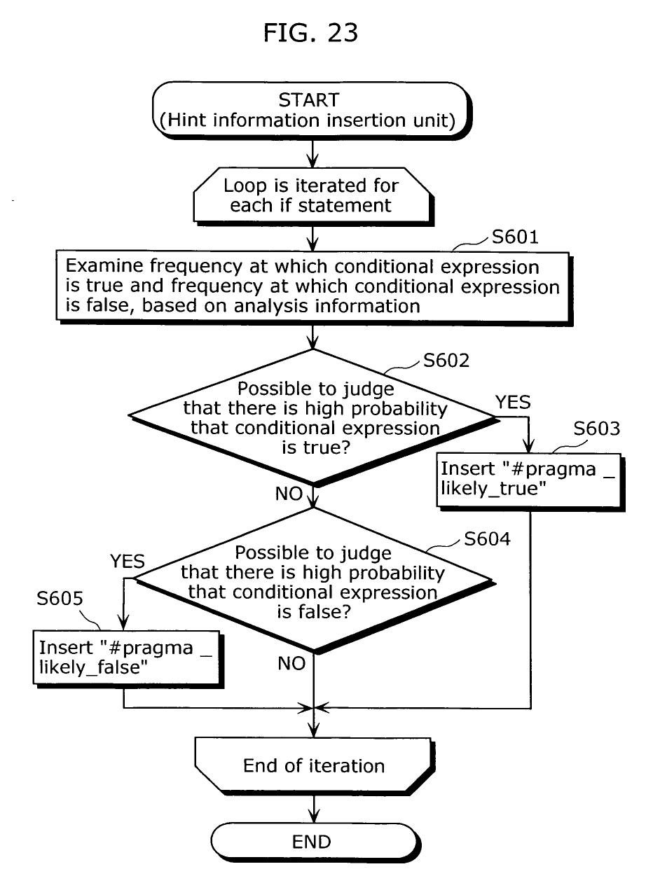

FIG. 23 is a flowchart showing the processing executed by the hint information insertion unit 108. The hint information insertion unit 108 repeats the following processing for each if statement included in the program 100. As shown in FIG. 20, an if statement “if(i %5==0)” is included in the program 100.

The hint information insertion unit 108 examines a frequency at which a conditional expression of a current if statement is true and a frequency at which the conditional expression is false, based on the analysis information 106 (S601). In the case where it is possible to judge that there is a high probability that the current conditional expression is true (YES in S602), a pragma “#pragma_likely_true”, which is a kind of the hint information indicating a high frequency at which a branch condition is true, is inserted immediately before a position at which the if statement is written (S603). This pragma is the first type of the hint information as presented above.

In the case where it is possible to judge that the conditional expression of the if statement is false (YES in S604), the hint information insertion unit 108 inserts, immediately before a position at which the if statement is written, a pragma “#pragma_likely_false” that is the type of the hint information indicating a high frequency at which a branch condition is false (S605). This pragma is the second type of the hint information as presented above. By the insertion of such pragma into the program 100, which is carried out by the hint information insertion unit 108, a program 101 that includes such hint information is created.

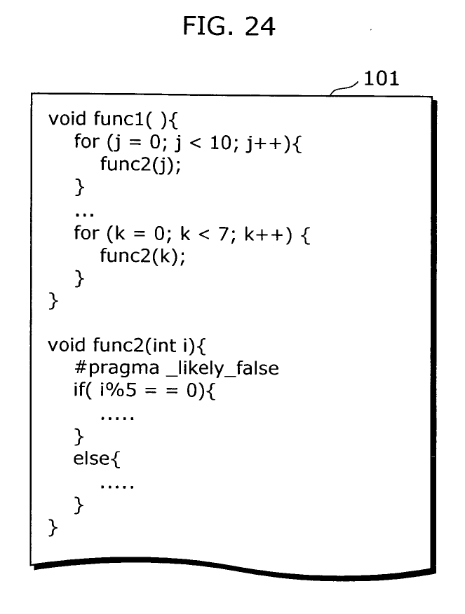

The following describes an example of a result of the insertion of a pragma, carried out by the hint information insertion unit 108. For example, focusing on the if statement “if(i %5==0)” in the program 100 shown in FIG. 20, a probability that the conditional expression “(i %5==0)” of the if statement will be true is 4/17 (a sum of the probability of 2/17 where the dummy argument “i” will indicate “0” and the probability of 2/17 where the dummy argument “i” will indicate “5”), according to the analysis information 106. Similarly, a probability that the conditional expression “(i %5==0)” of the if statement will be false is 13/17, according to the analysis information. The hint information insertion unit 108 therefore judges that there is a high probability that the conditional expression “(i %5==0)” of the if statement will be false. Therefore, the pragma “#pragma_likely_false” is inserted immediately before a position at which the if statement “if(i %5==0)” is written, as shown in FIG. 24. Thus, the program 101 that includes such hint information is created.

As has been described so far, it is possible to automatically insert the hint information related to static frequency (a frequency at which a branch condition is satisfied and a frequency at which the branch condition is not satisfied) into the program.

According to the present embodiment as described above, by inserting a pragma “#pragma_likely_true” into the program, the compiler can optimize a placement of machine-language instructions based on the pragma so that an instruction sequence which is executed at the time when a conditional expression using an if statement is true is executed with higher priority than an instruction sequence executed at the time when the if statement is false, that is, an instruction sequence specified by an else statement. Thus, it is possible to decrease an amount of the time required for the execution of a machine-language program.

Also, by inserting a pragma “#pragma_likely_false” into the program, the compiler can optimize a placement of machine-language instructions based on the pragma so that an instruction sequence executed at the time when a conditional expression using an if statement is false that is, an instruction sequence specified by an else statement, is executed with higher priority than an instruction sequence executed at the time when the if statement is true. Thus, it is possible to decrease an amount of the time required for the execution of a machine-language program.

### Fifth Embodiment, First Hint Information for Specifying Optimization Method

The present embodiment describes the program processing apparatus which automatically inserts, into a program, hint information that directly specifies an optimization method for the compiler. An example of such hint information may be hint information that specifies loop unrolling and hint information that specifies software pipelining.

The following describes the processing executed by the program processing apparatus 102 which automatically creates a program 101 that includes such hint information.

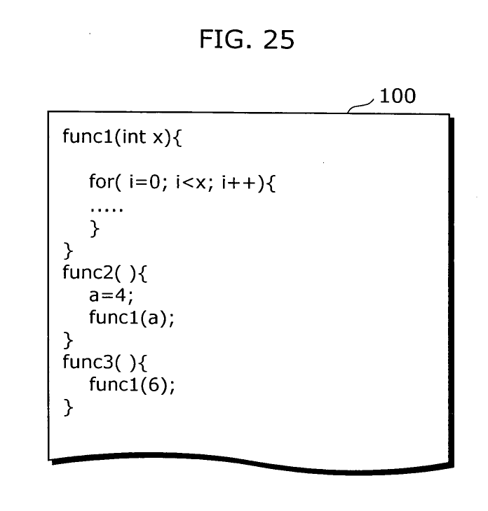

FIG. 25 shows an example of the program inputted into the program processing apparatus 102. Functions “func1”, “func2” and “func3” are included in a program 100.

The following describes the processing executed by the syntax analysis unit 104 and the hint information insertion unit 108 in the case where the program 100 is inputted.

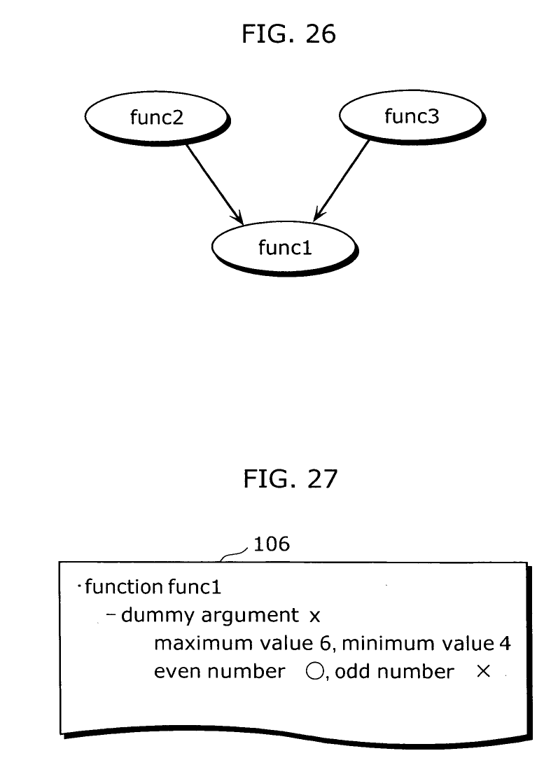

The syntax analysis information 104 executes the same processing as described in the flowchart shown in FIG. 5. FIG. 26 is a call flow graph created as a result of the processing described in S202 shown in FIG. 5. The call flow graph 107 shows that the functions “func2” and “func3” respectively calls the function “func1”.

FIG. 27 is a diagram showing the analysis information created as a result of the processing described in S203 and S204 shown in FIG. 5. The analysis information 106 shows that a maximum value of a dummy argument “x” in the function “func1” indicates “6” and the minimum value indicates “4”, and also that the dummy argument “x” always indicates an even number, but not an odd number. The processing of creating the analysis information 106 is as same as the processing described in the first embodiment, therefore, the detailed description will not be repeated here.

Next, processing executed by the hint information insertion unit 108 will be described.

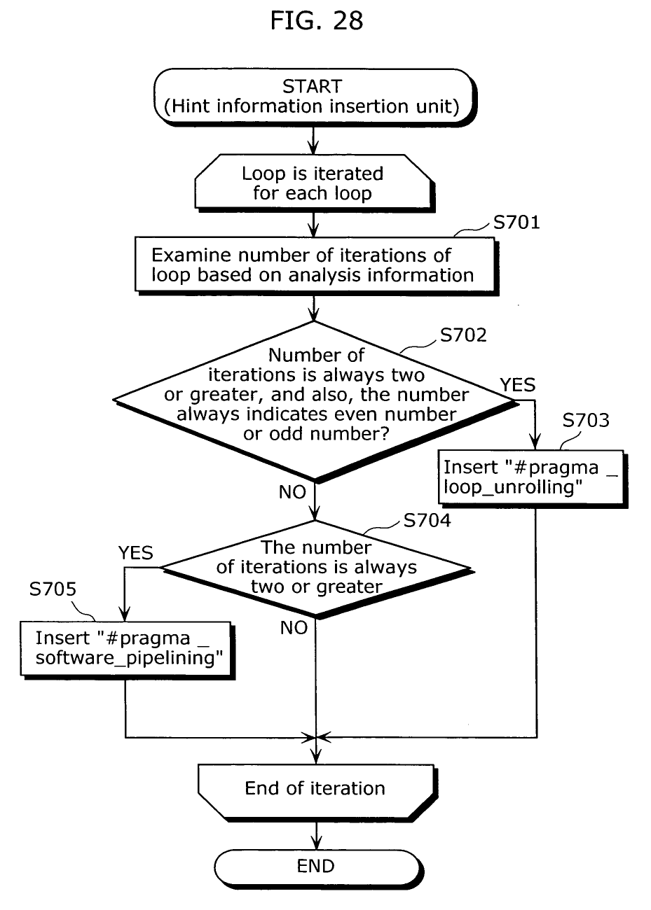

FIG. 28 is a flowchart showing the processing executed by the hint information insertion unit 108. The hint information insertion unit 108 repeats the following processing for each loop included in the program 100.

The hint information insertion unit 108 examines the number of iterations for a current loop process, based on the analysis information 106 (S701). In the case where the number of iterations of the current loop process is two or greater, and also, the number always indicates an odd number or an even number (YES in S702), the hint information insertion unit 108 inserts a pragma “#pragma_loop_unrolling” immediately before a position at which the current loop process is written (S703). This pragma is the hint information which instructs the compiler to perform loop unrolling optimization for the current loop process. It is assumed here that the number of iterations of unrolling is two.

In the case where the number of iterations for the current loop process may possibly indicate both an even number and an odd number, and the number is two or greater (YES in S704), the hint information insertion unit 108 inserts a pragma “#pragma_software_pipelining” immediately before a position at which the current loop process is written (S705). This pragma is the hint information which instructs the compiler to perform software pipelining optimization for the current loop process.

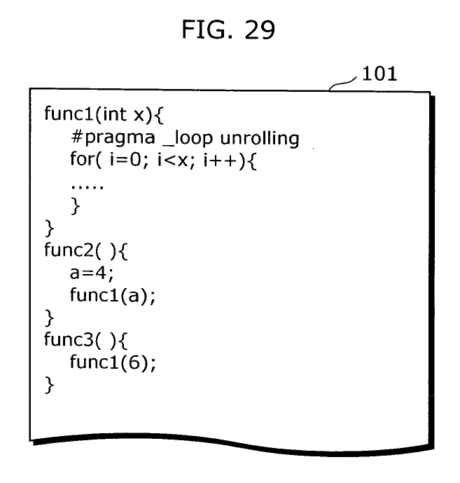

Next, an example of a result of the insertion of a pragma, carried out by the hint information insertion unit 108 will be described. For example, focusing on the for loop in the program 100 shown in FIG. 25, the analysis information 106 shown in FIG. 27 shows that the number of iterations of the for loop is always two or greater and that the number always indicates an even number. Therefore, the pragma “#pragma_loop_unrolling” is inserted as the hint information for the for loop into the program 101, as shown in FIG. 29, which is a result of the output performed by the hint information insertion unit 108.

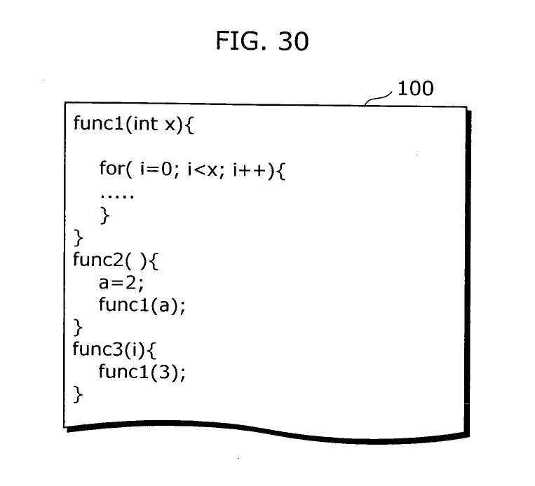

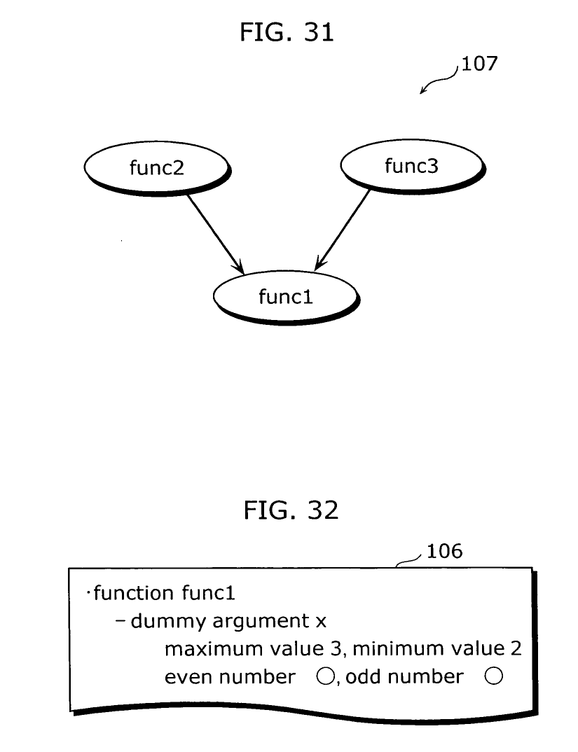

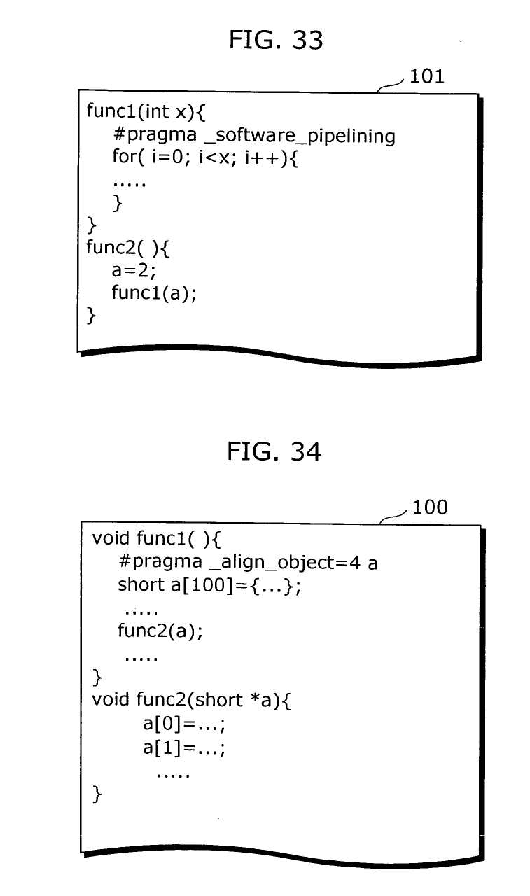

In the case where the program 100 as shown in FIG. 30 is inputted into the program processing apparatus 102, the syntax analysis unit 104 creates the call flow graph 107 as shown in FIG. 31 and the analysis information 106 as shown in FIG. 33. Focusing on the for loop in the program 100 shown in FIG. 30, the number of iterations of the for loop indicates both an odd number and an even number and the minimum value is two or greater, according to the analysis information 106. Therefore, the pragma “#pragma_software_pipelining” is inserted as the hint information for the for loop into the program 101, as shown in FIG. 32, which is a result of the output performed by the hint information insertion unit 108.

As described above, according to the present embodiment, it is possible to automatically insert, into the program, the hint information which directly gives a directive to the compiler to perform loop unrolling optimization.

It is also possible to automatically insert the hint information which directly gives a directive to the compiler to perform software pipelining optimization.

By inserting a pragma “#pragma_loop_unrolling” into the program 100, the compiler can perform loop unrolling optimization for the specified loop process. Thus, it is possible to cause the compiler to execute loop process with high speed at the execution of a machine-language program.

Also, by inserting a pragma “#pragma_software_pipelining” into the program 100, the compiler can perform software pipelining optimization for the specified loop process. Thus, it is possible to cause the compiler to execute the loop process with high speed at the execution of a machine-language program.

### Sixth Embodiment, Second Hint Information for Specifying Optimization Method

The present embodiment describes another program processing apparatus which automatically inserts, into a program, hint information that directly specifies an optimization method for the compiler. An example of such hint information may be hint information that specifies an output of a pair instruction.

The following describes the program processing apparatus 102 which automatically creates a program 101 that includes such information.

FIG. 34 shows an example of the program inputted into the program processing apparatus 102. Functions “func1” and “func2” are included in a program 100.

The following describes the processing executed by the syntax analysis unit 104 and the hint information insertion unit 108 in the case where the program 100 is inputted.

The syntax analysis 104 executes the same processing as described in the flowchart shown in FIG. 5. However, in the processing performed in S203, the difference is that an alignment value of an element in an array specified by a dummy argument in a function is analyzed. Note that the method of analyzing an alignment value is as same as the one described in the second embodiment. Therefore, the detailed description is not repeated here.

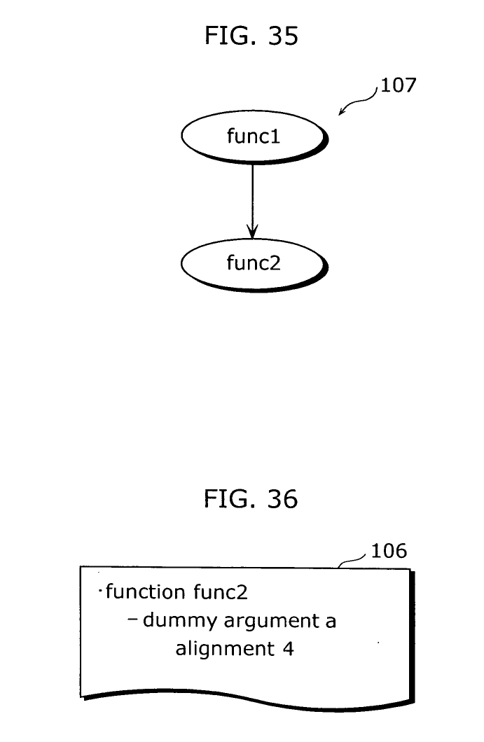

FIG. 35 is a diagram showing a call flow graph created as a result of the processing described in S202 shown in FIG. 5. The call flow graph 107 shows that the function “func1” calls the function “func2”.

FIG. 36 shows analysis information created as a result of the processing described in S203 and S204 shown in FIG. 5. The analysis information 106 indicates that data in the area indicated by a dummy argument “a” in the function “func2”, that is, each element in the array “a”, is aligned by a unit of 4 bytes.

Next, processing executed by the hint information insertion unit 108 will be described.

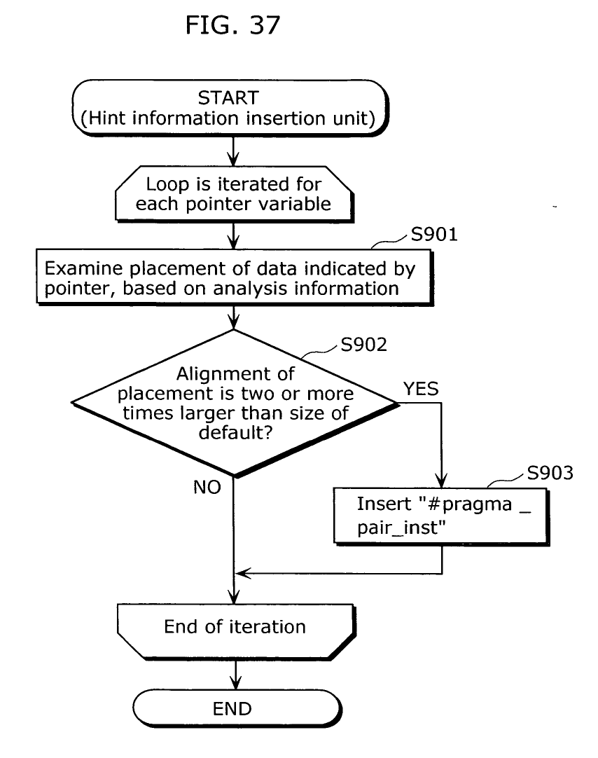

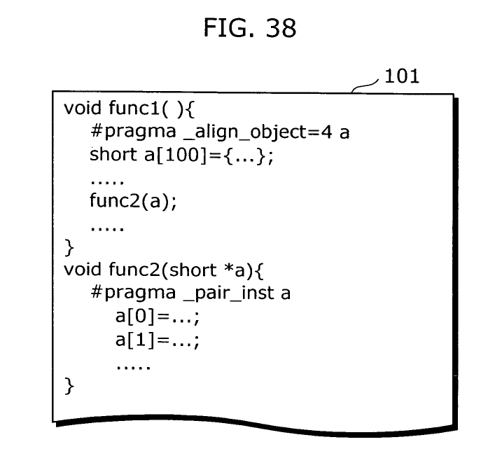

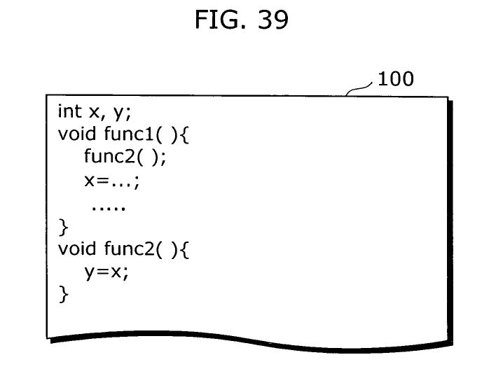

FIG. 37 is a flowchart showing the processing executed by the hint information insertion unit 108. The hint information insertion unit 108 repeats the following processing for each pointer variable included in the program 100.

The hint information insertion unit 108 examines a placement of data indicated by a current pointer variable, based on the analysis information 106 (S901). The hint information insertion unit 108 examines whether or not an alignment value of the data indicated by the current pointer variable is two or more times larger than an alignment value of a default (S902). In the case where the alignment value of the data indicated by the current pointer variable is two or more times larger than the alignment value of a default (YES in S902), a pragma “#pragma_pair_inst” is inserted in a position between a declaration of the pointer variable and a reference to the pointer variable. In the case where a current pointer variable “a” is processed, a pragma “#pragma_pair_inst a” is actually inserted. This pragma is a directive given to the compiler to issue a pair instruction for loading or writing, from the memory, at one time the data (e.g. an element in an array “a”) specified by the current pointer variable “a” so as to perform optimization.

The following describes an example of a result of the insertion of a pragma, carried out by the hint information insertion unit 108. For example, a dummy argument “a” of a pointer variable in the function “func2” shown in FIG. 34 is processed. The analysis information 106 shown in FIG. 36 shows that an alignment value of the dummy argument “a” is “4” and that the dummy argument “a” is a short type, which has a size of 2 bytes. This shows that an alignment value of the dummy argument “a” is two times larger than the alignment value of a default. Therefore, the pragma “#pragma_{—}pair_inst a” is inserted as the hint information for the dummy argument “a” (i.e. pointer variable “a”) into the program 101 that is a result of the output performed by the hint information insertion unit 108.

As described above, according to the present embodiment, it is possible to automatically insert the hint information which directly gives a directive to the compiler to output a pair instruction.

By inserting a pragma “#pragma_pair_inst a” into the program 100, the compiler can issue a pair instruction for loading or writing, from the memory, at one time the data indicated by the pointer variable “a”. Thus, it is possible to reduce the number of times for memory access, and thereby to speed up the processing.

### Seventh Embodiment, Third Hint Information for Specifying Optimization Method

The present embodiment describes another program processing apparatus which automatically inserts, into a program, hint information which directly specifies an optimization method for the compiler. The example of such hint information may be, for example, the hint information of built-in function which gives a directive on control processing performed on a cache memory.

The following describes the processing executed by the program processing apparatus 102 which automatically creates a program 101 that includes such hint information as described above.

FIG. 39 shows an example of the program inputted into the program processing apparatus 102. Functions “func1” and “func2” are included in a program 100.

The syntax analysis unit 104 executes the same processing as described in the flowchart shown in FIG. 5. However, in the processing described in S203, as in the case of the third embodiment, whether or not reading of data from a global variable and writing of data into a global variable is described in each function is analyzed.

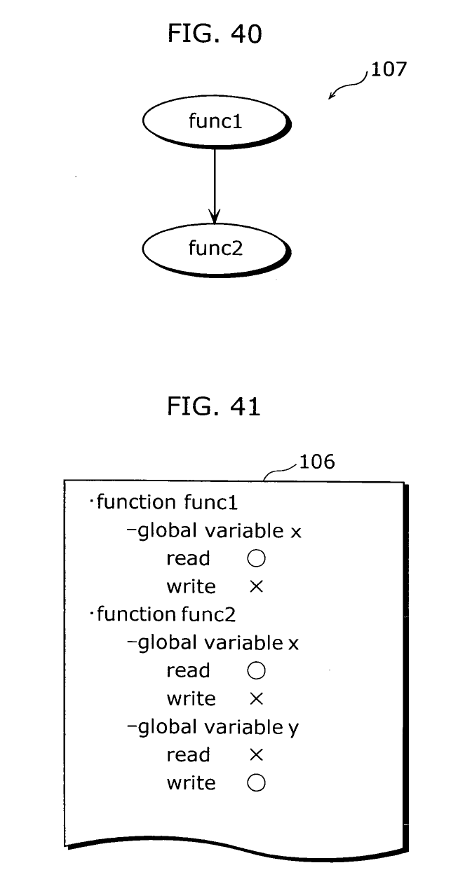

FIG. 40 is a diagram showing a call flow graph created as a result of the processing described in S202 shown in FIG. 5. The call flow graph 107 shows that the function “func1” calls the function “func2”.

FIG. 41 shows the analysis information created as a result of the processing described in S203 and S204 shown in FIG. 5. The analysis information 106 shows, for example, that reading from a global variable “x” and writing into a global variable “y” are executed in the function “func2”.

Next, processing executed by the hint information insertion unit 108 will be described.

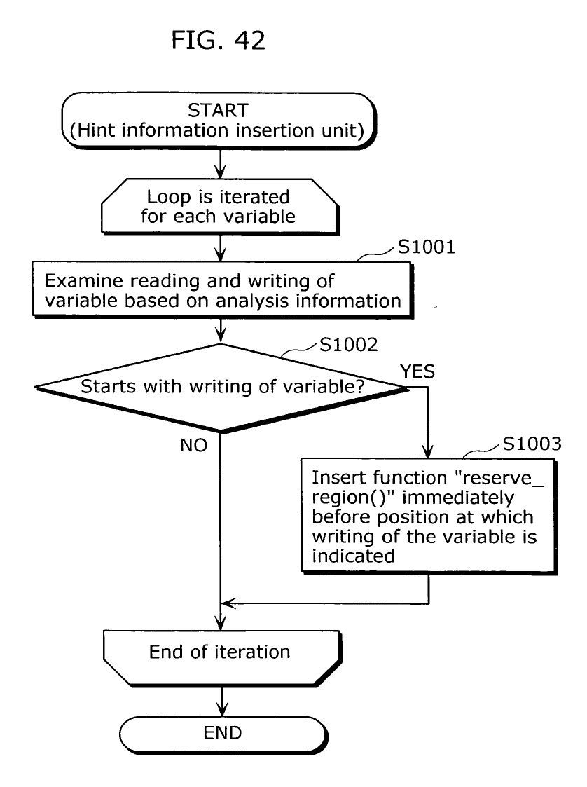

FIG. 42 is a flowchart showing the processing executed by the hint information insertion unit 108. The hint information insertion unit 108 repeats the following processing for each global variable included in the program 100.

The hint information insertion unit 108 examines reading of data from and writing of data into a current global variable, based on the analysis information 106 (S1001). In the case where an access to the current global variable starts with writing of data (YES in S1002), a built-in function “reserve_regiono( )” is inserted immediately before a position at which an execution of writing of data into the global variable is indicated (S1003). For example, in the case where a global variable is “a”, a built-in function “reserve_region(a)” is inserted. The built-in function “reserve_region(a)” is the hint information which gives a directive on control processing to be performed on a cache memory. The built-in function “reserve_region(a)” executes the processing in which only an area for storing a value of a variable is allocated, and a transfer (pre-fetch processing) of the value of the variable from a main memory to a cache memory is not operated.

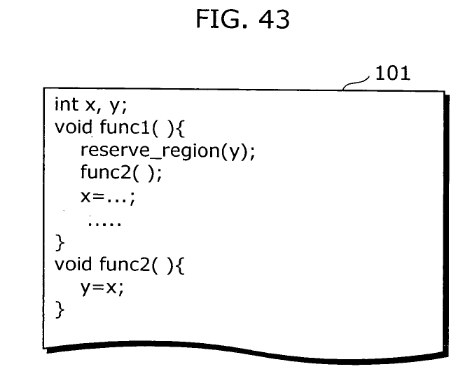

By inserting such pragma into the program 100, the program 101 as shown in FIG. 43, which includes such hint information is created.

The following describes an example of a result of the insertion of a pragma, carried out by the hint information insertion unit 108. For example, a global variable “y” in the program 100 shown in FIG. 39 is processed. Examining the analysis information 106 for writing of data into the global variable “y”, only writing of data is indicated in the function “func2”. This shows that an access to the global variable “y” starts with writing of data. The call flow graph 107 shows that the function “func2” is called by the function “func1”. Therefore, a built-in function “reserve_region(y)” is inserted immediately before a position at which the function “func2” is called in the function “func1”. Thus, the program 101 that includes such hint information is created.

As described above, according to the present embodiment, it is possible to automatically insert the hint information of built-in function that gives a directive on control processing to be performed on a cache memory or the like.

By inserting a built-in function “reserve_region()”, the compiler can perform optimization based on the built-in function so that an area is allocated in the memory for storing a value of a variable specified by an actual argument of the built-in function, and a transfer (pre-fetch) of a value of the variable from the main memory to the cache memory is not performed. Thus, it is possible to reduce the amount of the time for memory access at the execution of a machine-language program.

According to the first through seventh embodiments described above, it is possible to automatically correct a source program by automatically inserting hint information so that a satisfactory optimization can be performed even in the case where the user has not given the hint information as represented by a pragma.

The program processing apparatus according to the present invention is described based on the embodiments above, however, the present invention is not limited to these embodiments.

For example, after having received a program that already includes hint information, the program processing apparatus may correct errors in the hint information or replace the hint information with different hint information.

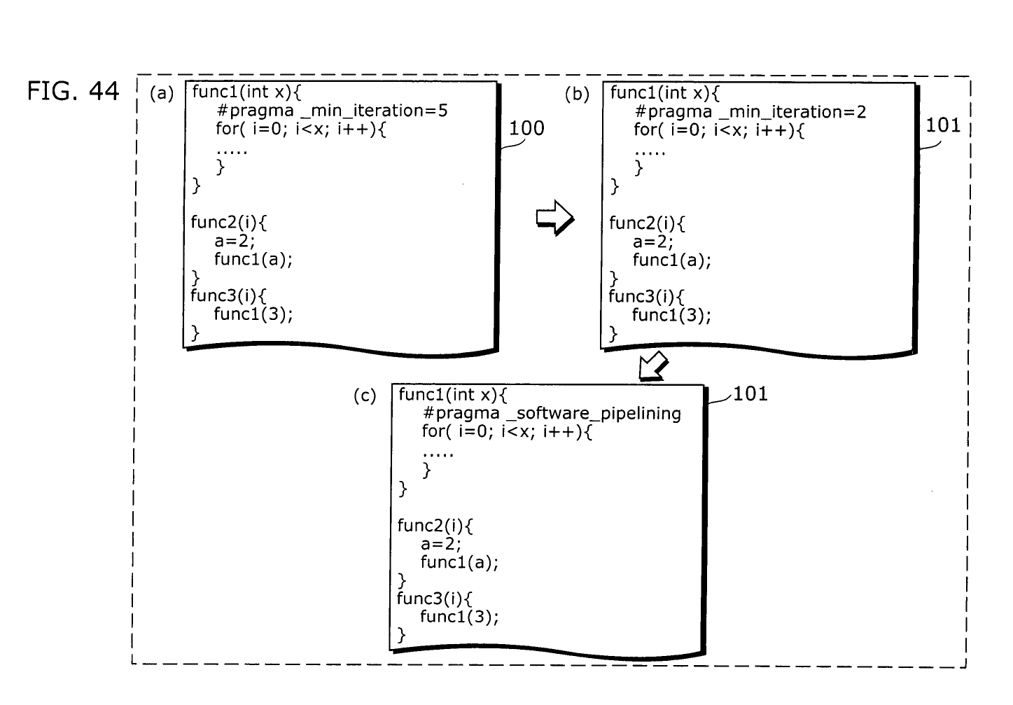

FIG. 44 is a diagram for describing correction and replacement of hint information. In the case where the program 100 that includes a pragma “#pragma_min_iteration=5”, as shown in FIG. 44(a), is given, the program processing apparatus 102 can obtain a pragma “#pragma_min_iteration=2” as a pragma to be given to a for loop of a function “func1”, by executing the same processing as described in the first embodiment. The program processing apparatus 102 may therefore generate a program 101, as shown in FIG. 44(b), in which the pragma “#pragma_min_iteration=5” included in the program 100 is corrected to the pragma “#pragma_min_iteration=2”.

By executing the same processing as described in the fifth embodiment, the program processing apparatus 102 can also obtain a pragma “#pragma_software_pipelining” as a pragma to be given to the for loop of the function “func1”. The program processing apparatus 102 may therefore create a program 101, as shown in FIG. 44(c), in which the pragma “#pragma_min_iteration=2” included in the program 101 shown in FIG. 44(b) is corrected to a pragma “#pragma_software_pipelining”.

By performing the processing as described above, it is possible to check hint information as represented by a pragma and correct a source program, so that a satisfactory optimization can be performed even in the case where the user proactively gives the hint information to the compiler.

It is also possible to check hint information as represented by a pragma and correct a source program, so that the compiler may not generate a wrong machine-language program.

It should be noted that in the case where a pragma “#pragma_min_iteration=n” (n is a integer of two or greater) is included in the program, the pragma may be automatically changed into a pragma “#pragma_software_pipelining” without analyzing the pragma in the program. In this way, it is possible to compile a program using a compiler that cannot interpret a pragma “#pragma_min_iteration” but can interpret a pragma “#pragma_software_pipelining”, which can heighten asset values of program.

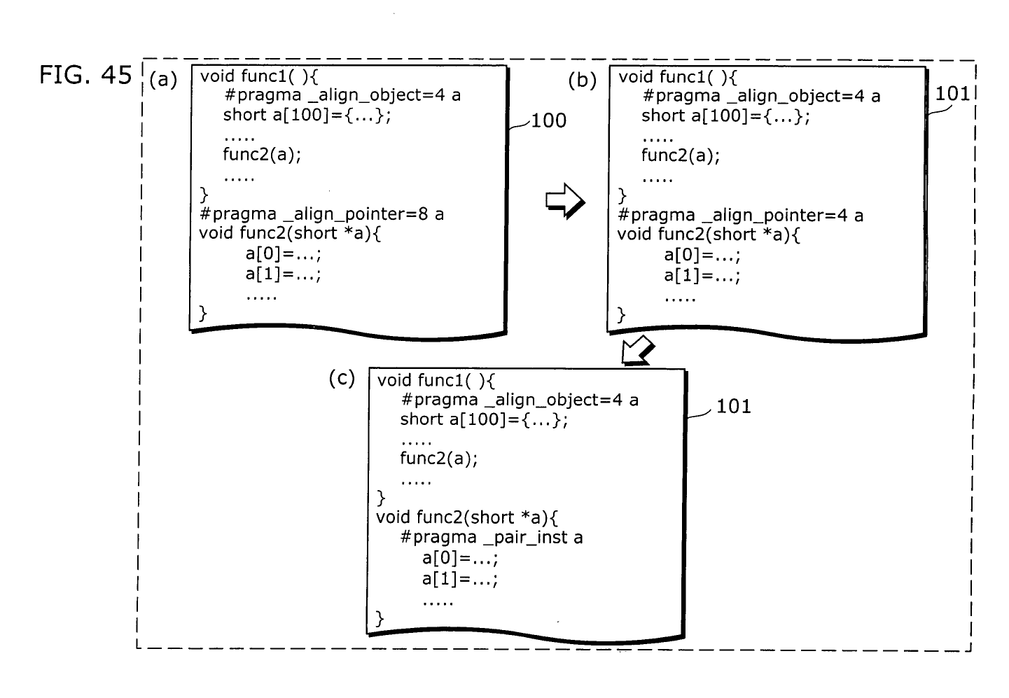

FIG. 45 is another diagram for describing correction and replacement of hint information. In the case where the program 100 that includes a pragma “#pragma_align_pointer=8a”, as shown in FIG. 45(a), is given, the program processing apparatus 102 can obtain a pragma “#pragma_align_pointer=4a” as a pragma to be given to a pointer variable “a” that is a dummy argument of a function “func2”, by executing the same processing as described in the second embodiment. The program processing apparatus 102 may therefore create a program 101 in which a pragma “#pragma_align_pointer=8a” included in the program 100 shown in FIG. 45(a) is corrected to a pragma “#pragma_align_pointer=4a”, as shown in FIG. 45(b).

By executing the same processing as descried in the sixth embodiment, the program processing apparatus 102 can also obtain a pragma “#pragma_pair_inst a” as a pragma to be given to the pointer variable “a” that is the dummy argument of the function “func2”. The program processing apparatus 102 may therefore create a program 101 in which the pragma “#pragma_align_pointer=4a” included in the program 101 shown in FIG. 45(b) is corrected to the pragma “#pragma_pair_inst a”, as shown in FIG. 45(c).

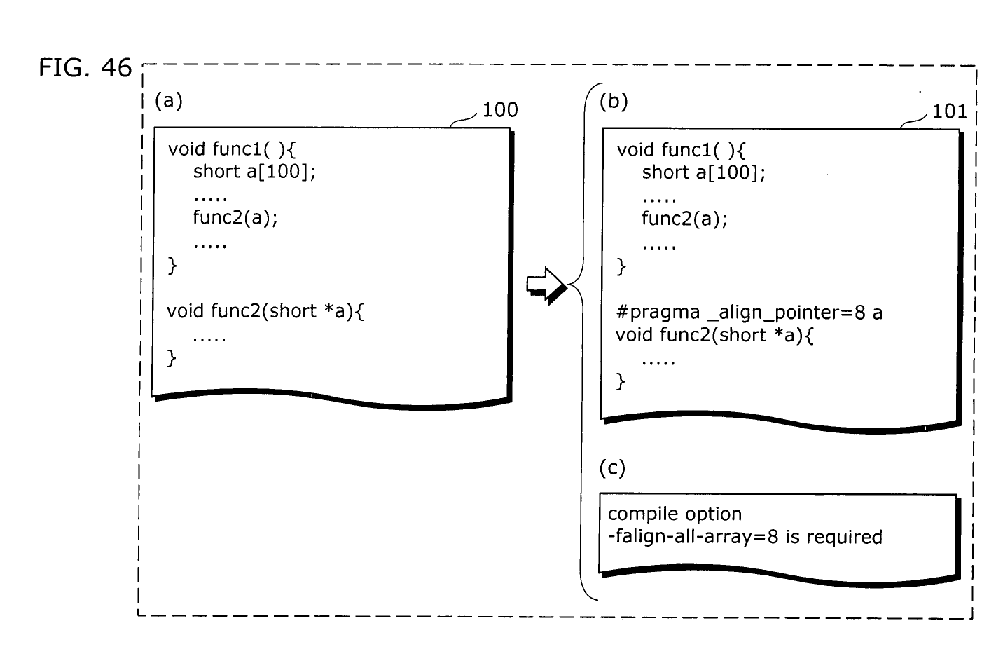

The program processing apparatus 102 may, at the same time, insert a pragma into a program and output a compile option. FIG. 46 is a diagram for describing the processing executed by the program processing apparatus 102 for outputting a compile option.

For example, in the case where the program 100 as shown in FIG. 46(a) is inputted, it is described in the above embodiments that the program processing apparatus 102 outputs the program 101 into which a pragma “#pragma_align_pointer=8a” is inserted, as shown in FIG. 46(b). The program processing apparatus 102, however, may output a compile option that is required for the compilation, as shown in FIG. 46(c). Note that “compile option” is a directive that is given to the compiler, which specifies a program 101 to be compiled, and that can be arbitrarily specified by the user. For example, when the program 101 “foo.c” is compiled, the user can input “cc-falign-all-array=8 foo.c” on a command line of the computer, using a command “cc”.

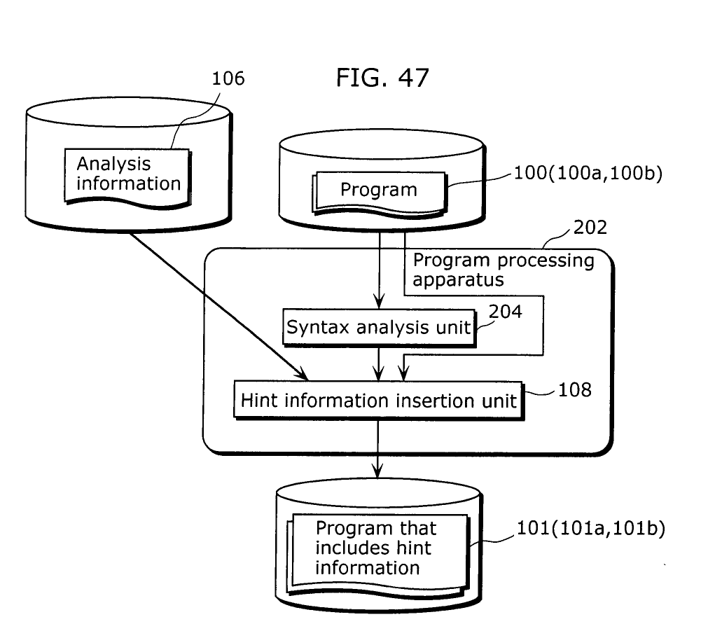

Moreover, a program processing apparatus 202 as shown in FIG. 47 may be used instead of the program processing apparatus shown in FIG. 3. The program processing apparatus 202 receives a program 100 written in a high-level language as well as analysis information 106 for the program 100, and automatically creates a program 101 that includes hint information which is represented by a pragma and is given to a compiler. Such program processing apparatus 202 includes a syntax analysis unit 204 and the hint information insertion unit 108. The syntax analysis unit 204 is a processing unit which receives the program 100 (i.e. 100a and 100b) and perform, on the program 100 (100a and 100b), a normal syntax analysis to be applied by the compiler. Note that the analysis information 106 is a result of the analysis performed on a program 100 (100a and 100b) that is different from the program 100 (100a and 100b) whose syntax is analyzed by the syntax analysis unit 204. For example, in the case where the program 100 is made up of programs 100a and 100b, analysis information 106 is created for the program 100a, and the program to be inputted into the syntax analysis unit 204 is the program 100b.

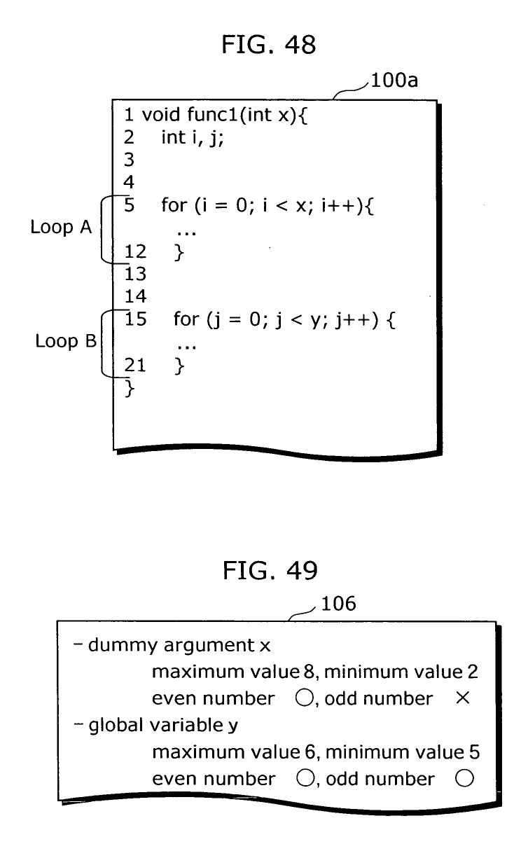

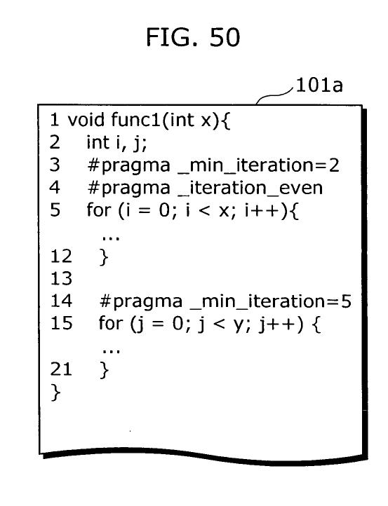

The structure of the hint information insertion unit 108 is as same as the one described above, therefore, the detailed description is not repeated here. FIG. 48 shows an example of the program 100a to be inputted into the program processing apparatus 202, while FIG. 49 shows an example of the analysis information 106 to be inputted into the program processing apparatus 202. As a result, a program 101a that includes hint information, as shown in FIG. 50 can be obtained from the program processing apparatus 202.

It is described that the programs 100 and 101 are source programs written in the C language, however, the programs 100 and 101 may be written in a high-level language such as the C++ language, or may be an object program, a program written in an intermediate language, or a program written in an assembly language.

In the above embodiment, a pragma is mainly used as one example of hint information, however, the hint information is not limited to the pragma, and a built-in function, a compiler option, or a reserved word written in a programming language may be used instead.

Furthermore, the number of iterations of unrolling executed in loop unrolling is not restricted to two, and it is possible to create a program 101 that includes hint information by performing the processing based on the same purport, even in the case where the number of iterations is two or greater.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a program processing apparatus which automatically generates hint information to be given to a compiler, and inserts the generated hint information into a program, and is particularly suitable as a pre-processor which automatically inserts hint information to be used for optimization that is performed when a program is compiled.

What is claimed is:

1. A program processing apparatus, wherein said apparatus (a) receives a first program, (b) creates a second program by inserting hint information into the first program, the hint information being logically consistent and being given to a compiler, and (c) outputs the second program.

2. The program processing apparatus according to claim 1, comprising:
a syntax analysis unit operable to analyze a syntax of the first program for generating analysis information; and
a hint information insertion unit operable (a) to create the second program by inserting the hint information into the first program based on the analysis information, and (b) to output the second program.

3. The program processing apparatus according to claim 2,
wherein said syntax analysis unit is operable to statically analyze the syntax of the first program, for generating the analysis information, and
said hint information insertion unit is operable (a) to create the second program by inserting static information as the hint information into the first program based on the analysis information, the static information being obtained by statically analyzing a program, and (b) to output the second program.

4. The program processing apparatus according to claim 3,
wherein said syntax analysis unit is operable to analyze the number of iterations of loop process included in the first program, for generating the analysis information which includes the number of iterations of the loop process, and
said hint information insertion unit is operable (a) to create the second program by inserting hint information into the first program based on the analysis information, the hint information being related to the number of iterations of the loop process, and (b) to output the second program.

5. The program processing apparatus according to claim 4,
wherein said hint information insertion unit is operable (a) to create the second program by inserting information as the hint information into the first program based on the analysis information, the information indicating a smallest number or a largest number of the number of iterations of the loop process, and (b) to output the second program.

6. The program processing apparatus according to claim 4,
wherein said hint information insertion unit includes:
an even number judgment unit operable to judge, based on the analysis information, whether or not the number of iterations of the loop process included in the first program always indicates an even number; and
a program output unit operable, in the case where said even number judgment unit judges that the number of iterations of the loop process always indicates an even number, (a) to create the second program by inserting information as the hint information into the first program, the information indicating that the number of iterations of the loop process always indicates an even number, and (b) to output the second program.

7. The program processing apparatus according to claim 4,
wherein said hint information insertion unit includes:
an odd number judgment unit operable to judge, based on the analysis information, whether or not the number of iterations of the loop process included in the first program always indicates an odd number; and
a program output unit operable, in the case where said odd number judgment unit judges that the number of iterations of the loop process always indicates an odd number, (a) to create the second program by inserting information as the hint information into the fist program, the information indicating that the number of iterations of the loop process always indicates an odd number, and (b) to output the second program.

8. The program processing apparatus according to claim 3,
wherein said syntax analysis unit is operable to analyze a placement of data included in the first program, for generating the analysis information which includes the placement of the data, and
said hint information insertion unit is operable (a) to create the second program by inserting hint information into the first program based on the analysis information, the hint information being related to the placement of the data, and (b) to output the second program.

9. The program processing apparatus according to claim 8, wherein said hint information insertion unit includes:
an alignment judgment unit operable to judge, based on the analysis information, whether or not the data included in the first program is aligned by a predetermined value; and
a program output unit operable, in the case where said alignment judgment unit judges that the data is aligned by a predetermined value, (a) to create the second program by inserting information as the hint information into the first program, the information specifying the data and indicating that the data is aligned by the predetermined value, and (b) to output the second program.

10. The program processing apparatus according to claim 3,
wherein said syntax analysis unit is operable to analyze an area accessed by a pointer variable included in the first program, for generating the analysis information which includes a result of the analysis, and
said hint information insertion unit is operable (a) to create the second program by inserting hint information into the first program based on the analysis information, the hint information being related to the area accessed by the pointer variable, and (b) to output the second program.

11. The program processing apparatus according to claim 10,
wherein said hint information insertion unit includes:
an overlap judgment unit operable to judge, based on the analysis information, whether or not the area accessed by the pointer variable included in the first program overlaps with an area accessed by another pointer variable; and
a program output unit operable, in the case where said overlap judgment unit judges that the areas do not overlap with each other, (a) to create the second program by inserting information as the hint information into the first program, the information indicating that the area accessed by the pointer variable does not overlap with the area accessed by the another pointer variable, and (b) to output the second program.

12. The program processing apparatus according to claim 3,
wherein said syntax analysis unit is operable to analyze reading of data from a variable included in the first program or writing of data into the variable, for generating the analysis information which includes a result of the analysis, and
said hint information insertion unit is operable (a) to create the second program by inserting hint information into the first program based on the analysis information, the hint information being related to reading of data from the variable or writing of data into the variable, and (b) to output the second program.

13. The program processing apparatus according to claim 12,
wherein said hint information insertion unit includes:
a writing judgment unit operable to judge, based on the analysis information, whether or not an access to the variable included in the first program starts with writing of data; and
a program output unit operable, in the case where said writing judgment unit judges that the access to the variable starts with writing, (a) to create the second program by inserting information as the hint information into the first program, the information specifying the variable and indicating that the access to the variable starts with writing of data, and (b) to output the second program.

14. The program processing apparatus according to claim 3,
wherein said syntax analysis unit is operable to analyze a static frequency at which a branch condition included in the first program is satisfied and a static frequency at which the branch condition is not satisfied, for generating the analysis information which includes a result of the analysis, and
said hint information insertion unit is operable (a) to create the second program by inserting hint information into the first program based on the result of the analysis, the hint information being related to the frequency at which the branch condition is satisfied and the frequency at which the branch condition is not satisfied, and (b) to output the second program.

15. The program processing apparatus according to claim 14,
wherein said hint information insertion unit includes:
a possibility judgment unit operable to judge that the branch condition included in the first program will be satisfied, based on the analysis information; and
a program output unit operable, in the case where it is judged that there is a high probability that said possibility judgment unit judges that the branch condition included in the first program will be satisfied, (a) to create the second program by inserting hint information into the first program, the hint information indicating that there is a high possibility that the branch condition will be satisfied, and (b) to output the second program.

16. The program processing apparatus according to claim 14,
wherein said hint information insertion unit includes:
a possibility judgment unit operable to judge that the branch condition included in the first program will be satisfied, based on the analysis information; and
a program output unit operable, in the case where it is judged that there is a high probability that said possibility judgment unit judges that the branch condition included in the first program will not be satisfied, (a) to create the second program by inserting hint information into the first program, the hint information indicating that there is a high possibility that the branch condition will not be satisfied, and (b) to output the second program.

17. The program processing apparatus according to claim 2,
wherein said syntax analysis unit is operable to statically analyze information related to a relationship between functions written in the first program, for generating the analysis information.

18. The program processing apparatus according to claim 2,
wherein said hint information insertion unit is operable to output a compile option as the hint information, the compile option being specified, when the compiler is activated, by a user for the first program which is to be compiled.

19. The program processing apparatus according to claim 18,
wherein the compile option is a directive on a method of placing data included in the first program.

20. The program processing apparatus according to claim 2,
wherein the first program includes first hint information, and
said hint information insertion unit is operable (a) to create the second program by inserting second hint information into the first program based on the analysis information, the second hint information being logically consistent and being given to the compiler, and (b) to output the second program.

21. The program processing apparatus according to claim 20,
wherein said hint information insertion unit is operable to correct a logical error in the first hint information and to generate the second hint information which reflects the correction.

22. The program processing apparatus according to claim 21,
wherein the first hint information is static information which can be obtained by statically analyzing the first program, and
the second hint information is optimization directive information which gives a directive on an optimization method for optimizing the second program.

23. The program processing apparatus according to claim 22,
wherein the first hint information is information related to the number of iterations of loop process specified in the first program, and
the second hint information is information which gives, for the loop process, a directive on a software pipelining optimization.

24. The program processing apparatus according to claim 22,
wherein the first hint information is information related to a placement of data included in the first program, and
the second hint information is information which gives a directive on an optimization based on a generation of a pair instruction, with respect to the first information.

25. The program processing apparatus according to claim 1,
wherein the hint information is information which gives a directive on an optimization method to be applied by a compiler to optimize a program.

26. The program processing apparatus according to claim 25,
wherein said syntax analysis unit is operable to analyze the number of iterations of loop process included in the first program, for generating analysis information which includes the number of iterations of the loop process, and
said hint information insertion unit is operable (a) to create the second program by inserting hint information into the first program based on the analysis information, the hint information giving a directive on a loop unrolling optimization of loop process, and (b) to output the second program.

27. The program processing apparatus according to claim 26,
wherein said hint information insertion unit includes:
a condition judgment unit operable to judge, based on the analysis information, whether or not both of the following conditions are satisfied in the case where the number of iterations of unrolling performed in loop unrolling is two: the number of iterations of the loop process included in the first program is two or greater; and the number always indicates either an even number or an odd number; and
a program output unit operable (a) to create the second program by inserting hint information into the first program, the hint information giving a directive on a loop unrolling optimization of the loop process which is included in the first program and satisfies the conditions, and (b) to output the second program.

28. The program processing apparatus according to claim 25,
wherein said syntax analysis unit is operable to analyze the number of iterations of loop process included in the first program, for generating analysis information which includes the number of iterations of the loop process, and
said hint information insertion unit is operable (a) to create the second program by inserting hint information into the first program based on the analysis information, the hint information giving a directive on a software pipelining optimization of loop process, and (b) to output the second program.

29. The program processing apparatus according to claim 28,
wherein said hint information insertion unit includes:
an iteration number judgment unit operable to judge, based on the analysis information, whether or not the number of iterations of the loop process specified in the hint information is n or greater, where n is an integer of 2 or greater, in the case where the number of iterations to be simultaneously executed is n; and
a program output unit operable (a) to create the second program by inserting hint information into the first program, the hint information giving a directive on a software pipelining optimization of loop process, for the loop process which is included in the first program and for which said iteration number judgment unit judges that the number of iterations of the loop process is n or greater, and (b) to output the second program.

30. The program processing apparatus according to claim 25,
wherein said syntax analysis information unit is operable to analyze an alignment value of data included in the first program, for generating analysis information which includes a result of the analysis, and
said hint information insertion unit includes:
a condition judgment unit operable to judge, based on the analysis information, whether or not the following condition is satisfied: the alignment value of the data included in the first program is two or more times larger than the size of the data; and
a program output unit operable (a) to create the second program by inserting hint information into the first program, the hint information giving, for the data which satisfies the condition, a directive on an optimization of data access based on a generation of a pair instruction, and (b) to output the second program.

31. The program processing apparatus according to claim 25,
wherein the hint information is information which specifies a variable and gives a directive on an optimization of control processing to be performed on a cache memory.

32. The program processing apparatus according to claim 31,
wherein said syntax analysis unit is operable to analyze reading of data from a variable included in the first program or writing of data into the variable, for generating analysis information which includes a result of the analysis, and
said hint information insertion unit includes:
a writing judgment unit operable to judge, based on the analysis information, whether or not an access to the variable included in the first program starts with writing of data; and
a program output unit operable, in the case where said writing judgment unit judges that the access to the variable starts with writing of data, (a) to create the second program by inserting hint information into a position immediately before a position in which the writing of data into the variable is indicated, in the first program, the hint information specifying the variable and instructing that an area should be allocated on the cache memory for storing a value of the variable, and (b) to output the second program.

33. The program processing apparatus according to claim 1,
wherein the first and second programs are written in the C language or the C++ language, and
the hint information is a pragma description which is a directive that is given to the compiler and that is describable in the first and second programs.
